(19) United States
(12) Patent Application Publication
(10) Pub. No.: US 2019/0281077 A1
(43) Pub. Date: Sep. 12, 2019

(54) SYSTEM AND METHOD FOR AUTOMATICALLY LEARNING SIGNATURES FOR OPERATIONS POLICIES

(71) Applicants: AT&T Intellectual Property I, L.P., Atlanta, GA (US); AT&T Mobility II LLC, Atlanta, GA (US)

(72) Inventors: Supratim Deb, Edison, NJ (US); Shobha Venkataraman, Jersey City, NJ (US); Zihui Ge, Madison, NJ (US); He Yan, Berkeley Heights, NJ (US); Jennifer Yates, Morristown, NJ (US); Sanjeev Ahuja, Aurora, IL (US); Sarat Puthenpura, Berkeley Heights, NJ (US)

(21) Appl. No.: 15/914,769

(22) Filed: Mar. 7, 2018

(51) Int. Cl. H04L 29/06; H04L 12/26; G06F 9/455; H04L 12/24

(52) U.S. Cl. CPC H04L 63/1425; H04L 43/04; G06F 2009/45595; G06F 9/45558; H04L 41/0631; H04L 43/0876

(57) ABSTRACT

A system for generating network policies includes a run-time execution platform configured to manage operations of a network, an analytics engine in communication with the run-time execution platform, an input-output interface associated with the analytics engine, and a processor coupled to the input-output interface and wherein the processor effectuates operations including creating a set of baseline performance statistics associated with the network, identifying an anomaly in the network, scoring the anomalies based on the identifying step, and setting policies for operation of the network using predictive analytics.

### TECHNICAL FIELD

This disclosure relates generally to mining measurement data, action logs and alarms to automatically develop policies to be applied to automate remedial action.

### BACKGROUND

Distributed, software-defined networks enable an operator to specify policies to enable the automated detection of events and then take actions to mitigate service problems. Determining the policies, however, is challenging because the collective operational knowledge that may be incorporated into such policies may be distributed across multiple operational centers with some remedial actions not being automated. Moreover, the knowledge for determining and implementing the policies may not be readily ascertainable by operations personnel because there is diverse data from a multiplicity of virtual network functions during different events. Additionally, there are often vendor-specific fault definitions and triggers and determining any underlying pattern of faults is difficult and resource intensive.

Currently known systems and methods are not sufficient to solve the problems associated with policy development and enforcement in a software define network. For example, predictive analytics based machine learning system which performs prediction of relevant events based on past occurrences for policy learning fails to account for the vast amount of domain specific collective operations intelligence which is very essential to mine meaning patterns out of very high-dimensional data. Rule based systems may be able to execute rules, however such systems are not necessarily configured for high dimensional numeric data which may be encountered in a software defined network. Moreover, operators may be called upon to manually stitch together multiple analytical steps to create signatures to be used in policy development.

In summary, none of the existing approaches combines machine learning with domain specific intelligence in a manner that is fully automated and still allows the system to be tuned based on specific use-cases. As such, there is a need to advance the state of the technological arts to automate the development and implementation of policies to develop remedial action policies, thereby lessening or eliminating any human involvement in the process.

### SUMMARY

The present disclosure is directed to a system for generating network policies including a run-time execution platform configured to manage operations of a network, an analytics engine in communication with the run-time execution platform, an input-output interface associated with the analytics engine; and a processor coupled to the input-output interface and wherein the processor is coupled to a memory, the memory having stored thereon executable instructions that when executed by the processor cause the processor to effectuate operations, the operations including creating a set of baseline performance statistics associated with the network, identifying an anomaly in the network, based on the identifying step, scoring the anomalies and setting policies for operation of the network. The identifying step may include receiving an input from monitoring of the network and the input includes one of an alarm, a sensor output, an action log, a maintenance log and a loading measurement. The identifying step may include an input from an operator or a set of vendor rules. The creating step may include creating statistical templates and/or generating spatio-temporal patterns of normal network operations. The spatio-temporal patterns may be updated periodically and may also include network failure modeling. The operations may also include generating at least one signature for each anomaly identified.

In an aspect, the network may be implemented using virtual network function and the operations may further include revising the policies based on receiving additional inputs and wherein the setting of the policies are based on predictive analytics. The operations may further include determining a source of the anomaly and providing a solution to correct the anomaly.

The present disclosure is also directed to a method including creating a statistical template for operation of a network, scoring a plurality of anomalies detected in the network, modeling symptoms of the plurality of the anomalies, grouping the symptoms, determining at least one signature for each symptom-group, and developing corrective actions for each subgroup. The method may further include developing rules for operation of the network and wherein the method is repeated based on further on inputs from the network. The developing step may be performed using predictive analytics. The method may further include receiving an input from the network wherein the input is one of an alarm, system log, maintenance log, a counter, and tickets.”

The present disclosure is also directed to an analytics engine including an input-output interface associated with the analytics engine, and a processor coupled to the input-output interface and wherein the processor is coupled to a memory, the memory having stored thereon executable instructions that when executed by the processor cause the processor to effectuate operations including receiving inputs from a network, creating a set of baseline performance statistics associated with the network, identifying anomalies in the network based on the identifying step, scoring the anomalies, and setting policies for operation of the network based on the scoring step and wherein the polices are set based on predictive analytics.

### BRIEF DESCRIPTION OF THE DRAWINGS

In the following description, for purposes of explanation, numerous specific details are set forth in order to provide an understanding of the variations in implementing the disclosed technology. However, the instant disclosure may take many different forms and should not be construed as limited to the examples set forth herein. Where practical, like numbers refer to like elements throughout.

FIG. 1 is a representation of an exemplary operating environment for the present disclosure showing a run time execution platform and the architecture associated therewith;

FIG. 2 is a representation of an exemplary block diagram illustrating the architecture as applied to the run-time execution platform of FIG. 1.

FIG. 3 is an exemplary operational block diagram

FIG. 4 is a functional block diagram of an exemplary system for the automatic generation of policies through machine learning.

FIG. 5 is a more detailed block diagram of an exemplary system for generation of policies through machine learning.

FIG. 6 is an exemplary functional diagram highlighting machine learning functions.

FIG. 7 is an exemplary flow diagram of the process for generating policies automatically for a run-time execution platform.

FIG. 8 shows an example signature from a prototype constructed in accordance with the present disclosure.

FIG. 9 is a representation of an exemplary software defined network.

FIG. 10 is a representation of an exemplary hardware platform for a network.

FIG. 11 is an illustration of a functional block diagram depicting one example of a Long Term Evolution-Evolved Packet System (LTE-EPS) network architecture.

FIG. 12 depicts an exemplary diagrammatic representation of a machine in the form of a computer system.

FIG. 13 illustrates a base station with a direct connection to Internet.

FIG. 14 is an example system including RAN and core network.

FIG. 15 illustrates an overall block diagram of an example packet-based mobile cellular network environment.

FIG. 16 illustrates an architecture of a typical General Packet Radio Service (GPRS) network.

FIG. 17 illustrates a Public Land Mobile Network (PLMN) block diagram view of an example architecture that may be replaced by a telecommunications system.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

Overview. As detailed herein, a virtual software defined network (SDN) comprising the Enhanced Control, Orchestration, Management and Policy (ECOMP) architecture enables the ability to put in place policies for automated detection of events, and then take automated actions for service problem mitigation. The present disclosure is directed to systems and methods for advancing the state of the technological arts by automatically learning these policies for service and network problem mitigation and remedial actions. The learned policies combine intelligence derived from diverse data sources and collective operations experience and as adapted through performance monitoring.

Generally, a run-time execution platform 10, which may, for example, be configured as an ECOMP platform, may be considered the intelligence in a SDN that provides lifecycle management and control of software-centric network resources, infrastructure and services. It will be understood that ECOMP is but one example of a run-time execution platform 10 which may serve as the operating environment for the present disclosure. The run time execution platform 10 may be a reusable platform of software assets and which may comprise the following functionality:

Service Design and Creation (SDC)—Provides a well-structured organization of visual design & simulation tools, templates and catalogs to model and create resources, services and products;

Master Service Orchestration (MSO)—Arranges, sequences and implements tasks based on policies and rules/recipes to coordinate the creation, modification or removal of logical and physical resources in the managed environment;

Data Collection, Analytics and Events (DCAE)—Provides real-time fault, performance, event and other data collection, correlation & analysis to manage service, network and infrastructure health and support closed loop automation;

Policy Modifiable Rules, Assertions and/or Conditions to enable real-time decision making on corrective actions and configuration changes in the software-centric network ecosystem;

Active and Available Inventory (A&AI)—tracks the dynamic relationships of virtualized networks, services & resources, their relationships and status to maintain ECOMP platform integrity and the global inventory it manages;

DN & Application Controller—SDN Controllers configure, monitor and maintain the health of network services and elements throughout their lifecycle. Application Controllers configure, monitor and maintains the health of an applications throughout their lifecycle; and

Portal—Provides a common portal framework and UI architecture for creating and operating virtual infrastructure and services. Examples of capabilities include common look and feel, role administration, access control, SDK with plug-ins and web components.

The system and method described in the present disclosure is highly flexible and may be configured for a variety of different domains and use cases. The description of the present disclosure herein is tailored toward implementation on cellular networks. However, the system and method of the present disclosure may be configured to any type of operations implemented using virtual network function. For example, the system and methods described herein would be applicable to virtual Multi-media Service Center (vMMSC) functionality or RAN functionality. The system and methods described herein would also be applicable to cloud-based operation solutions.

While the present disclosure describes the automation of the development and implementation in the context of run time execution platform policies, the system and method described herein and the claims appended hereto apply to the policy generation and implementation for SDNs generally. The solution automatically learns policies for service and network problem mitigation and remedial actions by combining intelligence, for example, machine learning, derived from diverse data sources such as KPIs, counters, alarms, logs, and the like.

While the present disclosure contains five main steps, it will be understood that the five steps may not be exhaustive and some of the steps may not necessarily be included in any solution.

Step 1 may provide a statistical baseline for various metrics based on time of day and loading and attributable to specific virtual network functions (VNFs). Step 1 may compute spatio-temporal statistical summaries of normal behavior of different network measurements across various VNFs.

Step 2 may compute an anomaly score for any measurement at any network element at any time by comparing current measurement values with the statistical baseline derived and documented by Step 1.

Step 3 may compute the primary symptoms associated with any potential service or maintenance issue. This step 3 may identify relevant symptoms from plethora of measurements from sensors, alarms, and the like. This component may be configurable based on various use-cases by defining the symptom-metrics that may be desired.

Step 4 may computes key signature-components per counter-category by extracting the counters and/or alarms that are most predictive of service impairment corresponding to any specific network-wide symptoms. This step may have the effect of automatically reducing what may be thousands of counters to identify tens of the most correlated counters. The components may be extracted on a per-counter category basis (for example, in the context of mobility RAN, categories include RRC-failure counters, hand-off counters etc.) to ensure that important signals from each category of counters is reflected in the final signature. This may be configurable to define which counters belong to which category.

Step 5 may involve developing the rules corresponding to each signature based on the correlated counters/alarms extracted in step 4. In essence, anytime a rule is satisfied, operations personnel will know the remedial steps to be taken under similar circumstances.

As such, the disclosure includes novel systems and methods that advance the state of the technological arts for automatically learning signatures used by operations' polices within a SDN. The system combines operational best practices with intelligence mined out of diverse data sources to develop network policies. The policies developed may lead to automation of remedial action steps. Moreover, the system is flexible and may be configured based on use-cases in that the automated processes provide operational personnel the ability to customize data extraction to configure the modules for each use case. Finally, disparate policies in various operational centers and among various VNFs may be standardized across the network.

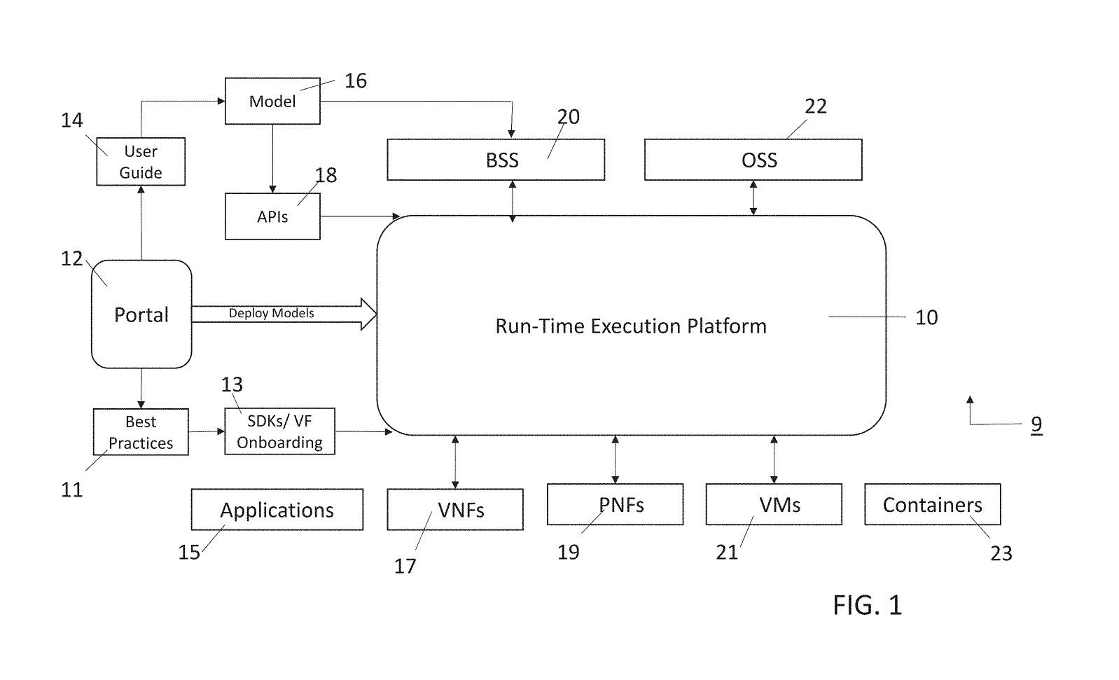

System Environment. With reference to FIG. 1, there is shown a system 9 in which the present disclosure may operate. The system 9 may be configured to support the provision, operation and maintenance of a wireless communication network which may, for example, be 3G, 4G/LTE, 5G, or any other wireless communication system now known or to be developed. The wireless communication network may be configured in part or in whole using software defined network components. The system 9 may include a run-time execution platform 10 which may, for example, be an ECOMP platform. The run-time execution platform 10 may also be referred to simply as platform 10 herein. The platform 10 may be a single entity that provides management functions in a uniform manner to onboard, deliver and manage the lifecycle of SDN resources and services. The applications that use the platform 10 may interact with the platform 10 via application program interfaces (APIs) 18 so as to not have to know all of the inner components that comprise platform 10 and system 9.

The platform 10 may be accessible by a portal 12 which may, for example, be a server or other device that is operable to access and control the platform 10 and through which user or service provider generated models may be deployed on platform 10. A user guide 14 may assist a user in creating models 16 for an application. The models 16, together with APIs 18, may then determine the resources desired for the business support systems (BSS) 2 which in turn, may access the platform 10 for placing orders, monitor usage and perform other accounting functions. The models 16 and APIs 18 may also be used to determine and request features, functionality and capacity of the operational support systems (OSS) 22, which may, for example, include capacity, fallout, and key performance indicators (KPIs) and the like.

The portal 12 may also provide access to best practices 11 with respect to SDN networks with respect to on-boarding and configuring new applications 15. Through the portal 12, users may access software development kits (SDKs) and virtual function on-boarding functions 13 to support models 16. From there, the platform 10 may control the instantiation of virtual network functions (VNFs) 17, physical network functions (PNFs) 18 and virtual machines (VMs) 21. The architecture, features, functionality and operation of SND networks as they may apply to 4G/LTE cellular or other wireless systems is described in greater detail below.

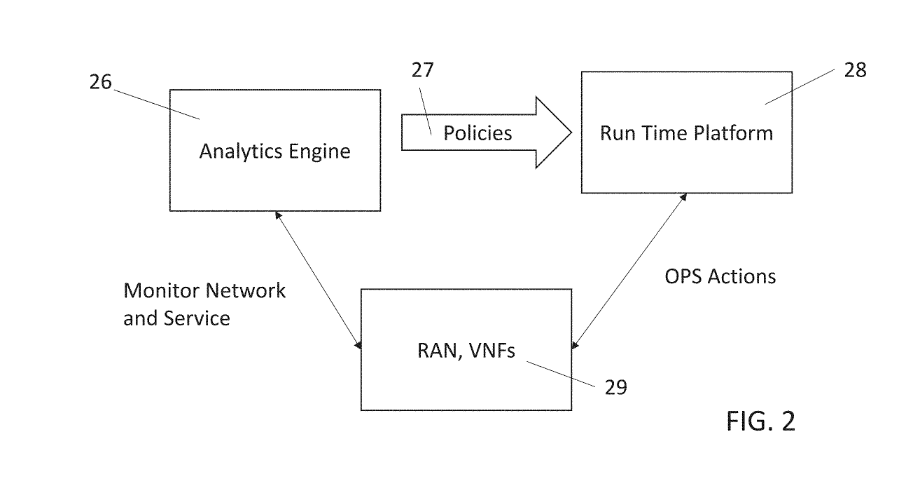

The operating environment is further described with reference to FIG. 2. There is shown an iterative system which includes radio access network (RAN) and VNF functions 29. Through the provision of services and monitoring of the network, operational policies may be learned and validated by the analytics engine 26. The policies 27 will then be applied to the run time platform 28 which in turn controls the RAN and VNF functions 29. This functional process continues as the development, implementation and validation of policies becomes better and better with machine learning.

Operation Description.

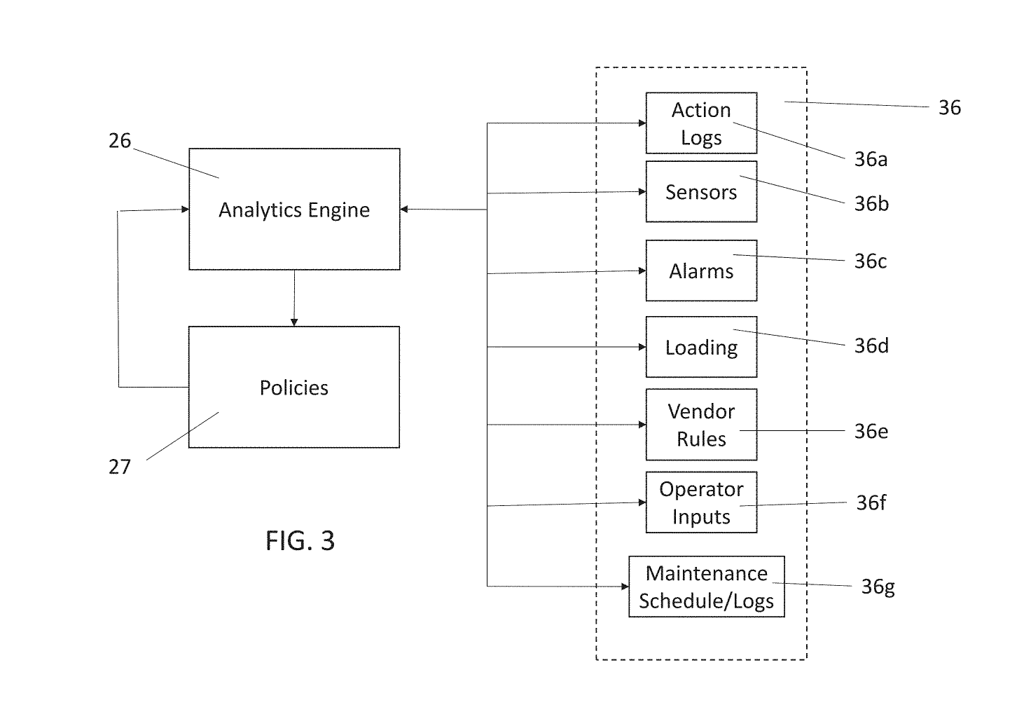

With reference to FIG. 3, there is shown an exemplary architecture in which analytics engine 26 receives inputs 36 to generate policies 27. A non-exhaustive list of example inputs 36 are shown, including action logs 36a, sensors 36b, alarms 36c, loading measurements 36d, vendor rules 36e, operator inputs 36f, and maintenance schedule and logs 36g. It will be understood that other inputs 36 generated by the network or run-time execution platform 10 may be included and that some of the exemplary inputs 36 may not be included, either way the list of potential inputs is included in the present disclosure. The analytics engine 26 may operate on the inputs 36 iteratively to develop policies 27 and continually or periodically monitor both the inputs 36 and current policies 27 to further define and refine the policies 27 using machine learning and/or artificial intelligence functionality.

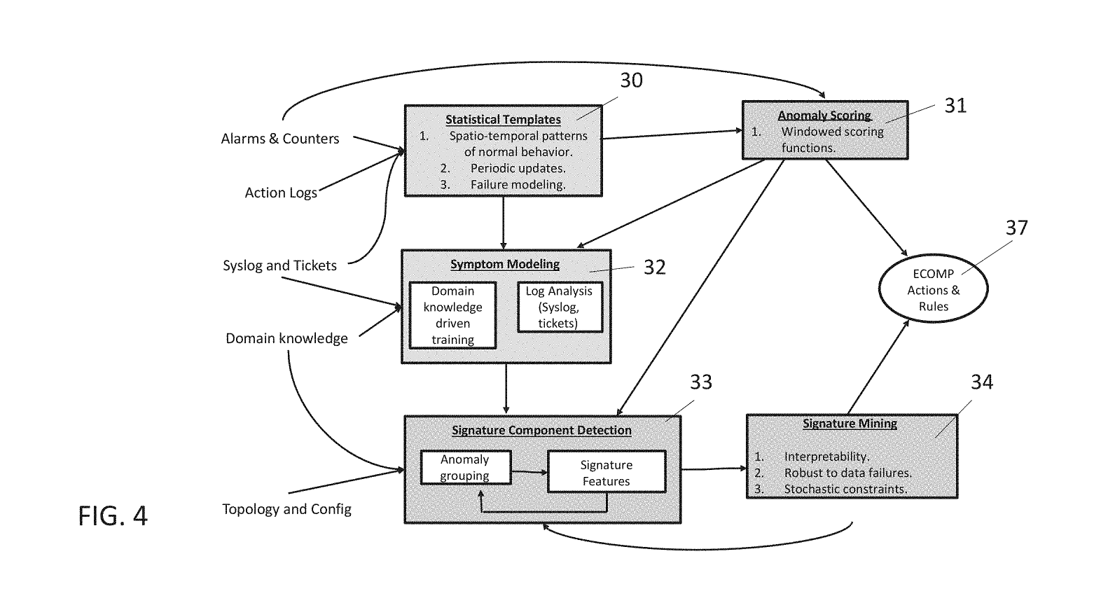

With reference to FIG. 4, there is shown a functional block diagram of an exemplary analytics engine 26 for the automatic generation of policies through machine learning. Baseline operational parameters and performance statistics may be calculated by the statistical templates function 30. This statistical templates function 30 may include, for example, spatio-temporal pattern analysis to create summaries of normal behavior of various network elements and the measurements associated with that normal behavior and run-time execution platform 10 operations. This provides a statistical baseline for how different metrics should behave based on time-of-day and the characteristics of specific network elements. This statistical templates function 30 may be repeated periodically to generate new baseline parameters and may also include initial failure analysis. As inputs, the statistical templates function 30 may include, for example, alarms, counters, action logs, system logs and trouble tickets.

Outputs of the statistical templates function 30 may be sent to the anomaly scoring function 31 which will analyze deviations from the statistical baseline functions. The anomaly scoring function 31 computes an anomaly score for any measurement at any network element at any time by comparing current measurement values with the statistical baselines from the network element at issue. The anomaly score may then be used in symptom modeling functions 32, signature component detection 33 and the development of policies and rules for the run-time execution platform 10.

Outputs of the statistical templates function 30 may also be sent to the symptom modeling function 32. The symptom modeling function 32 may receive system log and trouble tickets and perform analysis on those inputs. The symptom modeling function 32 may also receive domain knowledge to analyze to produce domain name training. The symptom modeling function 32 may also receive outputs from the anomaly scoring function 31. The system modeling function 32 computes the primary symptoms associated with any potential service issue. As such, the system modeling function 32 captures a step that may not been automatically performed in network service problem mitigation by identifying the symptom or symptoms from a plethora of measurements.

This system modeling function 32 may be configurable by an expert based on various use cases by defining the symptom-metrics. By way of example, the system modeling function may be tailored to model anomaly detection and remedial action for any particular cloud-based service such as, for example, radio access node (RAN) functionality. The system modeling function may use domain data associated with RAN functionality and various system logs and tickets, along with scoring of any anomalies, to develop domain signatures which support rules development. For example, the signatures may be defined to identify faults in the RAN functionality to determine when the service requires a reboot and if so, when such a reboot should occur. A second set of signatures may be developed which would provide rules that indicate any anomaly is simply a glitch and no action should be taken. In other words, the RAN domain could have different signatures for different anomalies or symptoms. Once that particular signature is detected, then the remedial action (or lack thereof) would be readily apparent to the system and/or an operator.

Signature families may be developed for a particular domain. For example, RAN functionality may have different signatures for different scenarios. The signature pool (also known as a signature family) may include the software version running on the VNF and the various possible symptoms or subset of symptoms. One signature out of the family of different signatures would then be applied by the policies.

A different domain may have a different set of signatures. For example, a virtual multimedia message system center (VMMSC) may have signatures relating to a specific technology, i.e., 4G/LTE, 5G, etc. with each specific technology having a corresponding deployment.

Another use case may include a new instance of a function. Based on the existing domain knowledge, a multitude of measurements of data may be compiled with a vastly reduced data set forming the basis of particular symptoms. In this manner, the components of symptoms may be configured. For example, symptom components may relate to memory utilization, throughput, CPU loading, or any other performance metric. In configuring the symptom components, the symptoms may then be defined and then characterize the measurements to each symptom. The signatures of each symptom are then learned to develop the policy.

Applying the systems and methods of the present disclosure in a manner described advances the state of the technological art significantly. By capturing a multitude of measurements, developing signature families for one or more domains with each signature in the signature family comprising a set of symptom components, policies for an entire domain or subset thereof may be created. By applying specially tailored AI based and/or rules based analytics to the signatures permits the real-time analysis of the anomaly and remediation steps to take, if any. None of this was possible with earlier techniques, including manual operation and remediation techniques, because the measurement data associated with virtual operational functions was too voluminous, not available, or ambiguous. With each new instance of a virtual function or the monitoring of an existing instance of a virtual function, a domain signature may be used to develop policies in real time. Not only does this advance the state of the art with respect to a run time execution platform described as an exemplary embodiment herein, but is equally applicable to any operational virtual function or cloud-based virtual function.

Another function of the analytics engine 26 may be a signature component detection function 33. This signature component detection function 33 may also receive outputs from the anomaly scoring function 31, topology and configuration data, and domain knowledge for further analysis. The signature component detection function 33 may include, for example, grouping of anomalies detected to develop operational signature features. For example, grouping of anomalies may include grouping a certain type of alarm that was detected in one geographic area with other detections of that same type of alarm that were received from other geographic areas. By doing so and analyzing the anomaly groups and combining this with signature features related to the network and the anomalies, the analytics engine 26 may perform a signature mining function 34 which interprets the results of the analysis, identifies the failure data and performs a statistical analysis to identify stochastic constraints on the data. As such, this signature component detection function 33 computes key signature-components per counter-category by extracting the counters and/or alarms that are most predictive of service impairment corresponding to any specific network-wide symptoms. This signature component detection function 33 reduces the thousands of counters to a more manageable number of counters by identifying the most correlated counters. The components are extracted on a per-counter category basis (for example, in the context of mobility RAN, categories include RRC-failure counters, hand-off counters etc.) such that important signals from each category of counters is reflected in the final signature. The classification of counters to category may be predetermined.

The signature mining function 34 learns rules corresponding to each signature based on the correlated counters/alarms extracted in the signature component detection function 33. By doing so, anytime a learned rule is satisfied, operations personnel will immediately know the remedial steps to take based on actions taken under similar circumstances. Additionally, such remedial steps may also be automated. The results of the signature mining function 34 and the anomaly scoring function 31 may then be used as the policies 37 for the run-time execution platform 10.

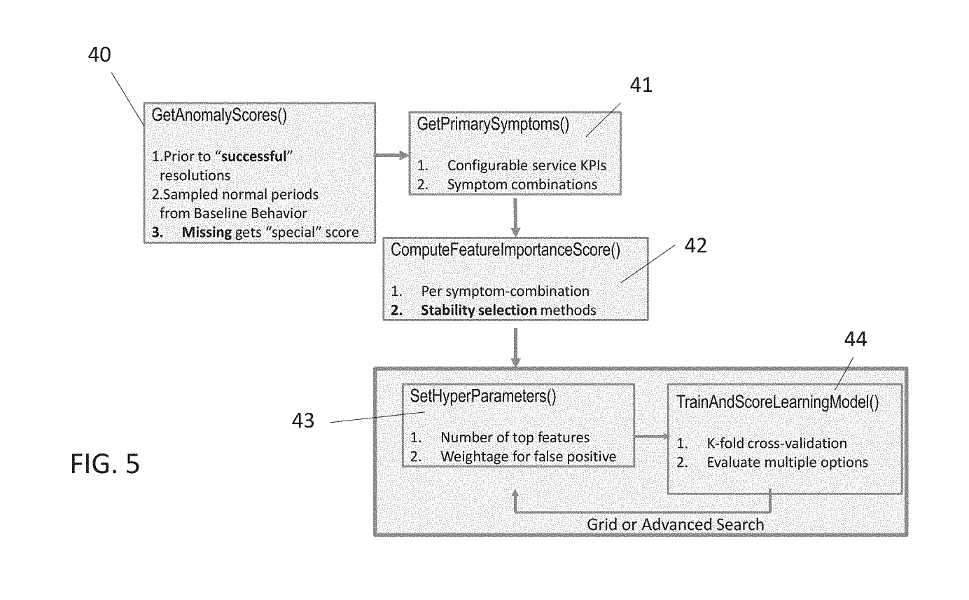

Further functional details are illustrated in FIG. 5. At 40, the anomaly scores may be obtained by using a GetAnomalyScore (parameters) function. This function may include sampling of normal baseline operations for the run-time execution platform 10 and an analysis of any anomalies, which may, for example, include but not be limited to alarms, reported prior to successfully eliminating the anomalies from the run-time execution platform 10. If there are missing data, a score for a particular anomaly or anomaly group may be estimated for further calculations. At 41, the symptoms of the anomalies may be determined using a GetPrimarySymptoms (parameters) function. This function may include combining symptoms and gathering relevant key performance indicators. At 42, a weighting function is performed using a ComputeFeatureImportanceScore (parameters) function. This weighting function may be applied on a per system combination basis and the stability selection methods for curing the anomalies. At 43, the weighted functions for various features are sorted and false positives are accounted for using the SetHyperParameters (parameters) function. This then feeds into 44 where the TrainAndScoreLearningModel (parameters) function is performed using cross-validation techniques while considering multiple options.

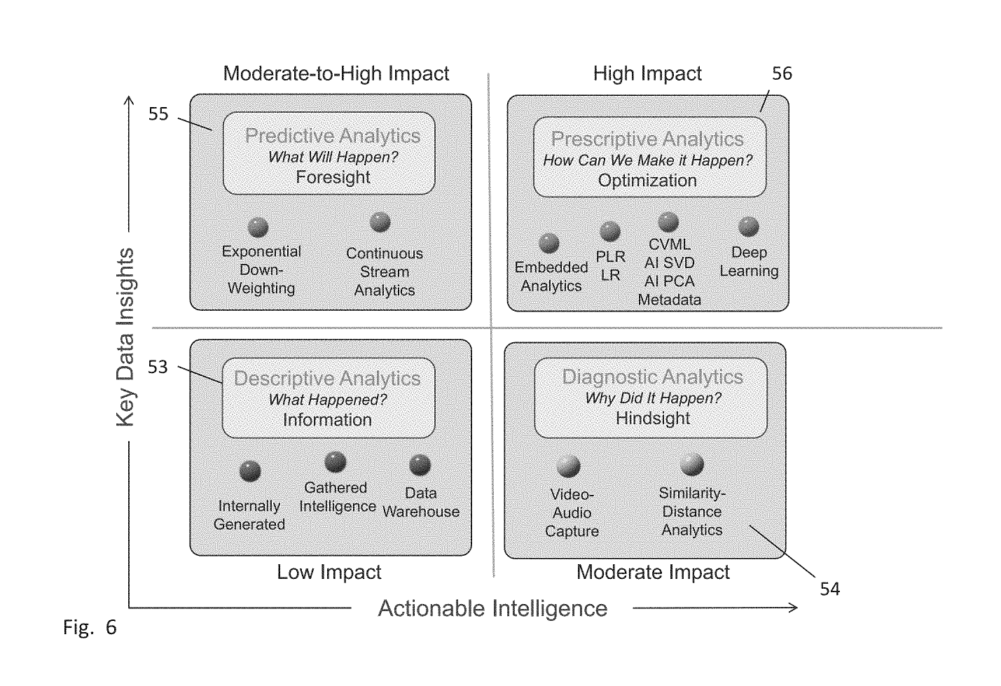

Analytics Functionality. With reference to FIG. 6, there is shown an example of how big data analytics may be used on the inputs 36 by the analytics engine 26 to develop policies. There are shown four functional quadrants wherein the horizontal axis shows a continuum for actionable intelligence and the vertical axis shows a continuum for key data insights. Within the lower left quadrant, there is shown a functional box labeled descriptive analytics 53. Generally, descriptive analytics is based on past events and may, for example, be based on internally generated reports based on the collected data and other gathered intelligence. Descriptive analytics 75 may generally be directed to “what happened”. In accordance with the present disclosure, the descriptive analytics performed by the analytics engine 26 may include the baseline parameters and operations of the statistical template function 30. It may also include a log of data received from inputs 36. As such, the “what happened” may include a complete description of what the baseline data showed and may, for example, include raw data or raw data formatted as a report.

To analyze “why it happened” the lower right quadrant shows an exemplary diagnostic analytics function 54. Such a diagnostic analytics function may include, for example, the analysis of inputs including operator notes and other inputs from external sources such as weather-related events or other system or environmental factors that may affect the operations of the run-time execution platform 10.

The diagnostic analysis 54 may, for example, include similarity-distance analytics, where similarity-distance analytics is generally defined as the “closeness” and similarity of two or more events may also include references to other similar events that happen in the past so as to correlate the previous diagnostics with the current diagnostic analysis. The analytics engine 26 may add this new data to any historical data to further develop the diagnostic capability for future uses in accordance with the present disclosure.

Moving to the upper left quadrant in FIG. 6, there is shown the predictive analytics function 55. The predictive analytics function 55 may fully implement the machine learning analysis process. The predictive analytics function 55 may be configured to predict the diagnosis of anomalies and the corrective remedial action to be taken based on the accumulated historical data and the artificial intelligence functions which may be resident in the analytics engine 50. The predictive analytics function 55 may, for example, include exponential down-weighting which, in an aspect, may preferentially compress a data stream into a single value that can be updated without having to save an entire dataset and in which more recently received data are weighted more than earlier-received data. This typically results in a down-weighting of older data, i.e., the data may decay over time. So as more historical diagnostic data are accumulated and the diagnosis becomes more accurate, it is those more recent diagnosis that will be weighted more heavily by the analytics engine 50 and thereby improve the predicted anomalies and remedial actions. Additionally, continuous stream analytics provide the foundation for fast adaptive actions based on complex event processing and event stream processing, permitting data to be processed before it lands in memory 40 or uploaded to database 20. This predictive analytics function 55 may support much faster decision making than possible with traditional data analytics technologies such as descriptive analytics 53 and diagnostic analytics 54. In other words, the predictive analytics function 55 may constantly be calculating the policies while managing and monitoring live inputs. The data being operated on may also include other information described above which is accessible to the analytics engine 50.

Finally, with respect to the upper right quadrant of FIG. 6, there is shown a prescriptive analytics function 56 which may, for example, optimize future outcomes. The analytics engine's 50 prescriptive analytics elements function 78 may include, for example, embedded analytics in which analytic functions are integrated within various operational processes to improve the efficiency of those operational processes.

The prescriptive analytics elements function 56 may also include predictive linear regression (PLR) in which an outcome is predicted based on a change of one of the input variables in terms of numeric and categorical inputs (dependent, or response variable), and logistic regression (LR), in which a binary outcome may be predicted based on an analysis of the input variables, where a probability is predicted that an instance belongs to a specific category, for example, the probability that a particular type of vehicle accident would cause a specific type and level of injury. For example, regression analysis may permit testing of a particular treatment to achieve a likely outcome and the effect a different treatment may have on the likely outcome. The PLR and LR elements may incorporate nearest-neighbor predictive algorithms (where ‘nearness’ may be basic Euclidean distance with resultant utility in selecting non-duplicate variables, rescale variables, and orthogonalizable variables). By way of further example, prescriptive analytics elements function 78 may also include continuous variable machine logic (CVML) which may include, for example, other statistical based functions including AI-based singular value decomposition (SVD), AI-based principal component analysis (PCA), and metadata. CVML may also include predictive linear regression. Deep learning functionality in which a cascade of processing layers may be analyzed layer by layer may also be used in the prescriptive analytics elements function 56.

It will be understood that these functions are exemplary only and other statistical methods and functionality may be used to implement any of the trauma kinematics diagnostic functions of the analysis engine 50. It will also be understood that some or all of the analytical processing may be off-loaded to a remote server or other servers which will collectively be referred to as analysis servers unless the context indicates otherwise.

Operational Flow Diagram.

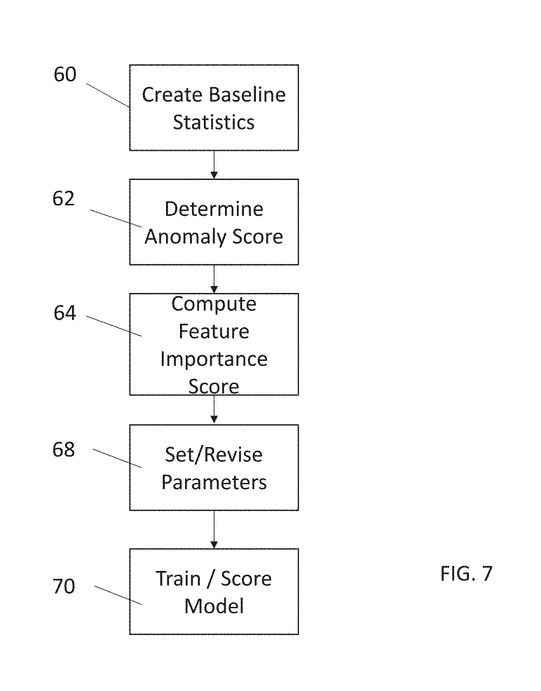

With reference to FIG. 7, there is shown an exemplary flow diagram illustrating one method of how the policy models may be developed. At 60, baseline statistics are compiled based on inputs 36 as described above with reference to FIG. 3. At 62, an anomaly score is determined. At 64, weighting is applied by computing a feature importance score. At 68, parameters are set and/or revised. At 70, a model is created based on machine learning training and scored. The process repeats continuously or periodically to further train the models with additional data.

Operationally, the system and method of the present disclosure may generate policies for the automation of remedial action. The system and method of the present disclosure may also automatically capture operational expertise that is distributed across multiple regions and create common policies in accordance with the expertise.

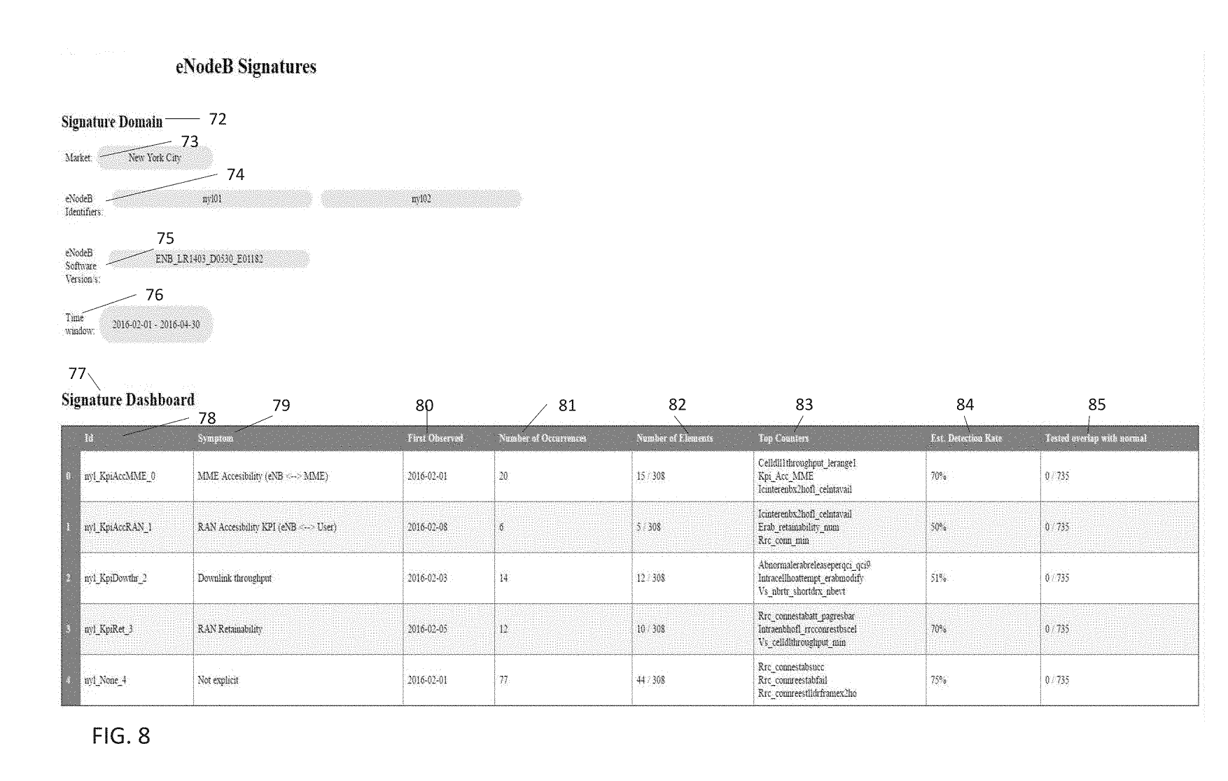

With reference to FIG. 8, there is shown an exemplary chart showing signatures for a network component for a pool of eNodeBs. There is shown in this example the signature domain 72 which may comprise the market 73, the component identifiers 74, the software version 75, and the time window during which measurements have been taken. Using inputs 36 and the processes described in the present disclosure, a signature dashboard 77 may be created. The signature dashboard may include an identification column 78 for an anomaly observed, which may, for example, include an identification of the network equipment and the key performance indicator which was observed as an anomaly or symptom. A symptom description in column 79 may be included, which in this exemplary table, row 1, shows a fault for accessibility from an eNodeB to the mobility management entity (MME). Column 80 is a date the anomaly was first observed. Column 81 shows the number of occurrences of the anomaly while column 82 identifies as a ratio the number of elements affected compared to the total number of elements. Column 83 identifies the counters used while column 84 identifies the estimated detection rate. Column 85 identifies the overlap with normal testing. In configuring the domain signatures, the detection rate 84 may be balanced against the false detection rate. In other words, giving up a small percentage on the detection rate may result in a much lower false detection rate. With such a trade-off, the amount of unnecessary reboots or other remedial measures may be minimized. With the signature dashboard compiled, the system may perform real-time predictions with respect to throughput, availability, reliability, maintenance and other operational parameters.

The system and method of the present disclosure may systematically automate the different steps of tedious and manual signature extraction while providing an operations-expert the flexibility to configure the modules based on the use-case.

Network Description, Software Defined Network Description.

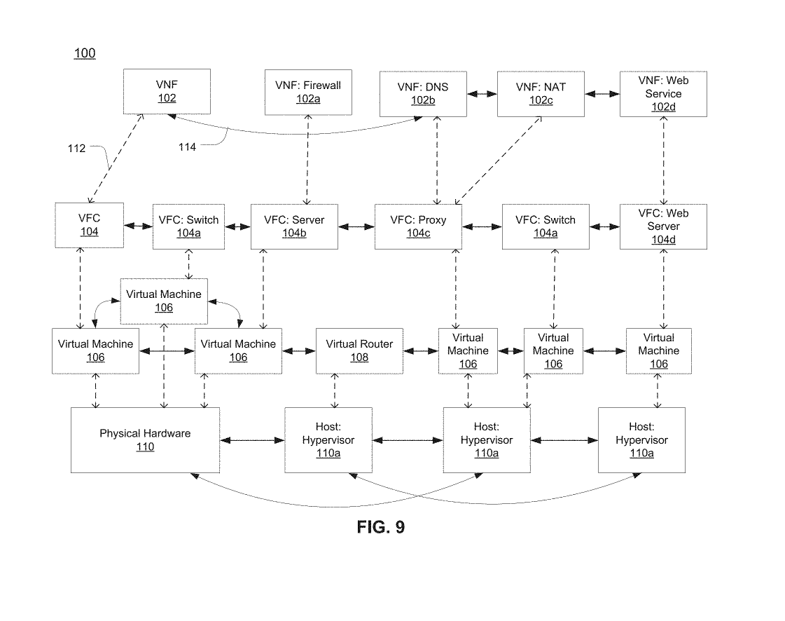

FIG. 9 is a representation of an exemplary network 100. Network 100 may comprise a Software Defined Network (SDN)—that is, network 100 may include one or more virtualized functions implemented on general purpose hardware, such as in lieu of having dedicated hardware for every network function. That is, general purpose hardware of network 100 may be configured to run virtual network elements to support communication services, such as mobility services, including consumer services and enterprise services. These services may be provided or measured in sessions

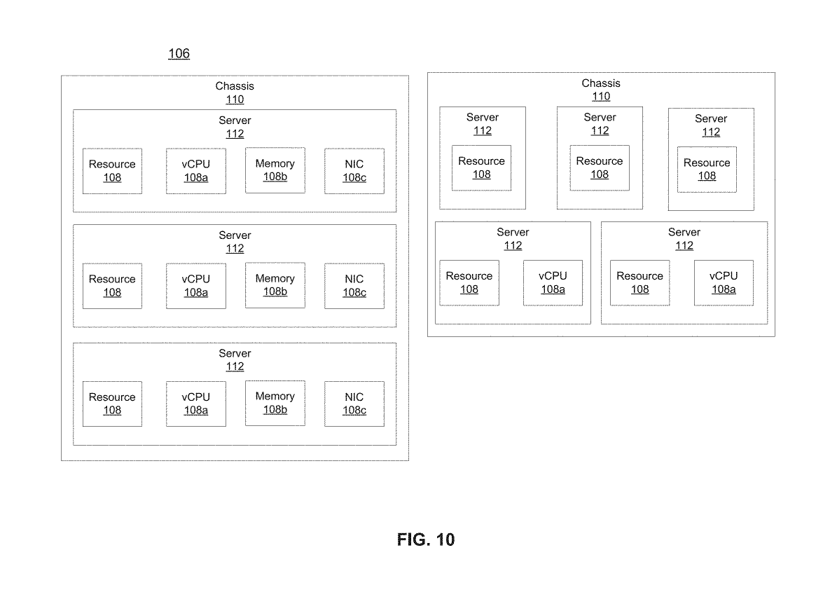

Virtual network functions (VNFs) 102 may be able to support a limited number of sessions. Each VNF 102 may have a VNF type that indicates its functionality or role. For example, FIG. 9 illustrates a gateway VNF 102a and a policy and charging rules function (PCRF) VNF 102b. Additionally or alternatively, VNFs 102 may include other types of VNFs. Each VNF 102 may use one or more virtual machines (VMs) 106 to operate. Each VM 106 may have a VM type that indicates its functionality or role. For example, FIG. 9 illustrates multiple VMs 106 that may include MCM VM, an ASM VM, and a DEP VM. Additionally or alternatively, VMs 106 may include other types of VMs. Each VM 106 may consume various network resources from a server 112, such as a resource 108, a virtual central processing unit (vCPU) 108a, memory 108b, or a network interface card (NIC) 108c in FIG. 10. Additionally or alternatively, server 112 may include other types of resources 108.

While FIG. 9 illustrates resources collectively contained in hardware platform 910, the configuration of hardware platform 911 may isolate, for example, certain memory 108b from other memory 108b FIG. 10 provides an exemplary implementation of hardware platform 910.

Hardware platform 911 may comprise one or more chasses 110. Chassis 110 may refer to the physical housing or platform for multiple servers 112 or other network equipment. In an aspect, chassis 110 may also refer to the underlying network equipment. Chassis 110 may include one or more servers 112. Server 112 may comprise general purpose computer hardware or a computer. In an aspect, chassis 110 may comprise a metal rack, and servers 112 of chassis 110 may comprise blade servers that are physically mounted in or on chassis 110.

Each server 112 may include one or more network resources 108, as illustrated. Servers 112 may be communicatively coupled together (not shown) in any combination or arrangement. For example, all servers 112 within a given chassis 110 may be communicatively coupled. As another example, servers 112 in different chasses 110 may be communicatively coupled. Additionally or alternatively, chasses 110 may be communicatively coupled together (not shown) in any combination or arrangement.

The characteristics of each chassis 110 and each server 112 may differ. For example, FIG. 10 illustrates that the number of servers 112 within two chasses 110 may vary. Additionally or alternatively, the type or number of resources 108 within each server 112 may vary. In an aspect, chassis 110 may be used to group servers 112 with the same resource characteristics. In another aspect, servers 112 within the same chassis 110 may have different resource characteristics.

Given hardware platform 911, the number of sessions that may be instantiated may vary depending upon how efficiently resources 108 are assigned to different VMs 106. For example, assignment of VMs 106 to particular resources 108 may be constrained by one or more rules. For example, a first rule may require that resources 108 assigned to a particular VM 106 be on the same server 112 or set of servers 112. For example, if VM 106 uses eight vCPUs 108a, 1 GB of memory 108b, and 2 NICs 108c, the rules may require that all of these resources 108 be sourced from the same server 112. Additionally or alternatively, VM 106 may require splitting resources 108 among multiple servers 112, but such splitting may need to conform with certain restrictions. For example, resources 108 for VM 106 may be able to be split between two servers 112. Default rules may apply. For example, a default rule may require that all resources 108 for a given VM 106 must come from the same server 112.

An affinity rule may restrict assignment of resources 108 for a particular VM 106 (or a particular type of VM 106). For example, an affinity rule may require that certain VMs 106 be instantiated on (that is, consume resources from) the same server 112 or chassis 110. For example, if VNF 102 uses six MCM VMs 106, an affinity rule may dictate that those six MCM VMs 106 be instantiated on the same server 112 (or chassis 110). As another example, if VNF 102 uses MCM VMs 106, ASM VMs 106, and a third type of VMs 106, an affinity rule may dictate that at least the MCM VMs 106 and the ASM VMs 1046 be instantiated on the same server 112 (or chassis 110). Affinity rules may restrict assignment of resources 108 based on the identity or type of resource 108, VNF 102, VM 106, chassis 110, server 112, or any combination thereof.

An anti-affinity rule may restrict assignment of resources 108 for a particular VM 106 (or a particular type of VM 106). In contrast to an affinity rule—which may require that certain VMs 106 be instantiated on the same server 112 or chassis 110—an anti-affinity rule requires that certain VMs 106 be instantiated on different servers 112 (or different chasses 110). For example, an anti-affinity rule may require that MCM VM 106 be instantiated on a particular server 112 that does not contain any ASM VMs 106. As another example, an anti-affinity rule may require that MCM VMs 106 for a first VNF 102 be instantiated on a different server 112 (or chassis 110) than MCM VMs 106 for a second VNF 102. Anti-affinity rules may restrict assignment of resources 108 based on the identity or type of resource 108, VNF 102, VM 106, chassis 110, server 112, or any combination thereof.

Within these constraints, resources 108 of servers 112 may be assigned to be used to instantiate VMs 106, which in turn may be used to instantiate VNFs 102, which in turn may be used to establish sessions. The different combinations for how such resources 108 may be assigned may vary in complexity and efficiency. For example, different assignments may have different limits of the number of sessions that can be established given a particular server 112.

For example, consider a session that may require gateway VNF 102a and PCRF VNF 102b. Gateway VNF 102a may require five VMs 106 instantiated on the same server 112, and PCRF VNF 102b may require two VMs 104 instantiated on the same server 112. (Assume, for this example, that no affinity or anti-affinity rules restrict whether VMs 106 for PCRF VNF 102b may or must be instantiated on the same or different server 112 than VMs 106 for gateway VNF 102a). In this example, each of two servers 112 may have sufficient resources 108 to support 10 VMs 106. To implement sessions using these two servers 112, first server 112 may be instantiated with 10 VMs 106 to support two instantiations of gateway VNF 102a, and second server 112 may be instantiated with 9 VMs: five VMs 106 to support one instantiation of gateway VNF 102a and four VMs 106 to support two instantiations of PCRF VNF 102b. This may leave the remaining resources 108 that could have supported the tenth VM 108 on second server 112 unused (and unusable for an instantiation of either a gateway VNF 102a or a PCRF VNF 102b). Alternatively, first server 112 may be instantiated with 10 VMs 106 for two instantiations of gateway VNF 102a and second server 112 may be instantiated with 10 VMs 106 for five instantiations of PCRF VNF 102b, using all available resources 108 to maximize the number of VMs 106 instantiated.

Consider, further, how many sessions each gateway VNF 102a and each PCRF VNF 102b may support. This may factor into which assignment of resources 108 is more efficient. For example, consider if each gateway VNF 102a supports two million sessions, and if each PCRF VNF 102b supports three million sessions. For the first configuration—three total gateway VNFs 102a (which satisfy the gateway requirement for six million sessions) and two total PCRF VNFs 102b (which satisfy the PCRF requirement for six million sessions)—would support a total of six million sessions. For the second configuration—two total gateway VNFs 102a (which satisfy the gateway requirement for four million sessions) and five total PCRF VNFs 102b (which satisfy the PCRF requirement for 15 million sessions)—would support a total of four million sessions. Thus, while the first configuration may seem less efficient looking only at the number of available resources 108 used (as resources 108 for the tenth possible VM 106 are unused), the second configuration is actually more efficient from the perspective of being the configuration that can support more the greater number of sessions.

To solve the problem of determining a capacity (or, number of sessions) that can be supported by a given hardware platform 911, a given requirement for VNFs 102 to support a session, a capacity for the number of sessions each VNF 102 (e.g., of a certain type) can support, a given requirement for VMs 106 for each VNF 102 (e.g., of a certain type), a given requirement for resources 108 to support each VM 106 (e.g., of a certain type), rules dictating the assignment of resources 108 to one or more VMs 106 (e.g., affinity and anti-affinity rules), the chasses 110 and servers 112 of hardware platform 911, and the individual resources 108 of each chassis 110 or server 112 (e.g., of a certain type), an integer programming problem may be formulated.

First, a plurality of index sets may be established. For example, index set L may include the set of chasses 110. For example, if a system allows up to 6 chasses 110, this set may be:
L={1, 2, 3, 4, 5, 6},

where l is an element of L.

Another index set J may include the set of servers 112. For example, if a system allows up to 16 servers 112 per chassis 110, this set may be:
J={1, 2, 3, . . . , 16},

where j is an element of J

As another example, index set K having at least one element k may include the set of VNFs 102 that may be considered. For example, this index set may include all types of VNFs 102 that may be used to instantiate a service. For example, let
K={GW, PCRF}

where GW represents gateway VNFs 102a and PCRF represents PCRF VNFs 102b.

Another index set I(k) may equal the set of VMs 106 for a VNF 102 k. Thus, let
I(GW)={MCM, ASM, IOM, WSM, CCM, DCM}

represent VMs 106 for gateway VNF 102a, where MCM represents MCM VM 106, ASM represents ASM VM 106, and each of IOM, WSM, CCM, and DCM represents a respective type of VM 106. Further, let
I(PCRF)={DEP, DIR, POL, SES, MAN}

represent VMs 106 for PCRF VNF 102b, where DEP represents DEP VM 106 and each of DIR, POL, SES, and MAN represent a respective type of VM 106.

Another index set V may include the set of possible instances of a given VM 104. For example, if a system allows up to 20 instances of VMs 106, this set may be:
V={1, 2, 3, . . . , 20},

where v is an element of V.

In addition to the sets, the integer programming problem may include additional data. The characteristics of VNFs 102, VMs 106, chasses 110, or servers 112 may be factored into the problem. This data may be referred to as parameters. For example, for given VNF 102 k, the number of sessions that VNF 102 k can support may be defined as a function S(k). In an aspect, for an element k of set K, this parameter may be represented by
S(k)>=0;

as a measurement of the number of sessions k can support. Returning to the earlier example where gateway VNF 102a may support 2 million sessions, then this parameter may be
S(GW)=2,000,000.

VM 106 modularity may be another parameter in the integer programming problem. VM 106 modularity may represent the VM 106 requirement for a type of VNF 102. For example, for k that is an element of set K and i that is an element of set I, each instance of VNF k may require M(k, i) instances of VMs 106. For example, recall the example where
I(GW)={MCM, ASM, IOM, WSM, CCM, DCM}.

In an example, M(GW, I(GW)) may be the set that indicates the number of each type of VM 106 that may be required to instantiate gateway VNF 102a. For example,
M(GW, I(GW))={2, 16, 4, 4, 2, 4}

may indicate that one instantiation of gateway VNF 102a may require two instantiations of MCM VMs 106, 16 instantiations of ACM VM 106, four instantiations of IOM VM 106, four instantiations of WSM VM 106, two instantiations of CCM VM 106, and four instantiations of DCM VM 106.

Another parameter may indicate the capacity of hardware platform 910. For example, a parameter C may indicate the number of vCPUs 108a required for each VM 106 type i and for each VNF 102 type k. For example, this may include the parameter
C(k, i).

For example, if MCM VM 106 for gateway VNF 102a requires 20 vCPUs 108a, this may be represented as
C(GW, MCM)=20.

However, given the complexity of the integer programming problem—the numerous variables and restrictions that must be satisfied—implementing an algorithm that may be used to solve the integer programming problem efficiently, without sacrificing optimality, may be difficult.

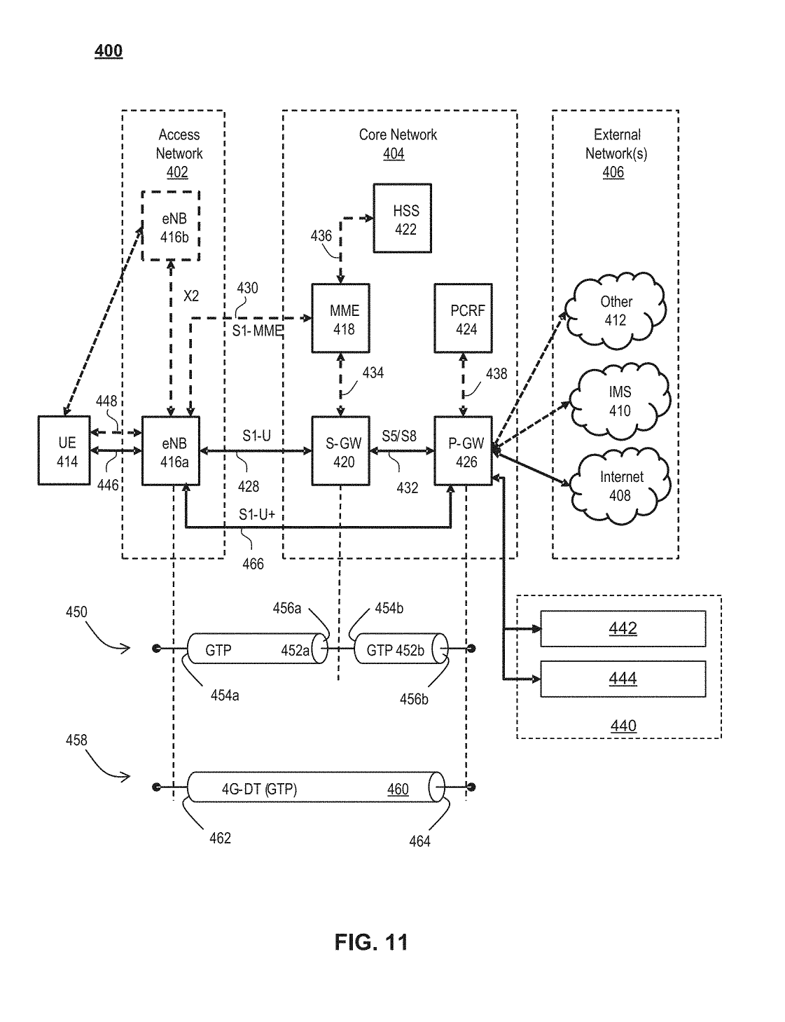

FIG. 11 illustrates a functional block diagram depicting one example of an LTE-EPS network architecture 400 that may be at least partially implemented as an SDN. Network architecture 400 disclosed herein is referred to as a modified Long Term Evolution/Evolved Packet System (LTE-EPS) architecture 400 to distinguish it from a traditional LTE-EPS architecture.

An example modified LTE-EPS architecture 400 is based at least in part on standards developed by the 3rd Generation Partnership Project (3GPP), with information available at www.3gpp.org. LTE-EPS network architecture 400 may include an access network 402, a core network 404, e.g., an Evolved Packet Core (EPC) or Common BackBone (CBB) and one or more external networks 406, sometimes referred to as PDN or peer entities. Different external networks 406 can be distinguished from each other by a respective network identifier, e.g., a label according to DNS naming conventions describing an access point to the PDN. Such labels can be referred to as Access Point Names (APN). External networks 406 can include one or more trusted and non-trusted external networks such as an internet protocol (IP) network 408, an IP multimedia subsystem (IMS) network 410, and other networks 412, such as a service network, a corporate network, or the like. In an aspect, access network 402, core network 404, or external network 406 may include or communicate with network 100.

Access network 402 can include an LTE network architecture sometimes referred to as Evolved Universal mobile Telecommunication system Terrestrial Radio Access (E UTRA) and evolved UMTS Terrestrial Radio Access Network (E-UTRAN). Broadly, access network 402 can include one or more communication devices, commonly referred to as User Equipment (UE) 414, and one or more wireless access nodes, or base stations 416a, 416b. During network operations, at least one base station 416 communicates directly with UE 414. Base station 416 can be an evolved Node B (e-NodeB), with which UE 414 communicates over the air and wirelessly. UEs 414 can include, without limitation, wireless devices, e.g., satellite communication systems, portable digital assistants (PDAs), laptop computers, tablet devices and other mobile devices (e.g., cellular telephones, smart appliances, and so on). UEs 414 can connect to eNBs 416 when UE 414 is within range according to a corresponding wireless communication technology.

UE 414 generally runs one or more applications that engage in a transfer of packets between UE 414 and one or more external networks 406. Such packet transfers can include one of downlink packet transfers from external network 406 to UE 414, uplink packet transfers from UE 414 to external network 406 or combinations of uplink and downlink packet transfers. Applications can include, without limitation, web browsing, Voice over IP (VoIP), streaming media and the like. Each application can pose different Quality of Service (QoS) requirements on a respective packet transfer. Different packet transfers can be served by different bearers within core network 404, e.g., according to parameters, such as the QoS.

Core network 404 uses a concept of bearers, e.g., EPS bearers (virtual connections between UEs and Packet Gateways, PGWs), to route packets, e.g., IP traffic, between a particular gateway in core network 404 and UE 414. A bearer refers generally to an IP packet flow with a defined QoS between the particular gateway and UE 414. Access network 402, e.g., E UTRAN, and core network 404 together set up and release bearers as required by the various applications. Bearers can be classified in at least two different categories: (i) minimum guaranteed bit rate bearers, e.g., for applications, such as VoIP; and (ii) non-guaranteed bit rate bearers that do not require guarantee bit rate, e.g., for applications, such as web browsing.

In one embodiment, the core network 404 includes various network entities, such as Mobility Management Entity (MME) 418, Serving Gateway (SGW) 420, Home Subscriber Server (HSS) 422, Policy and Charging Rules Function (PCRF) 424 and Packet Data Network Gateway (PGW) 426. In one embodiment, MME 418 comprises a control node performing a control signaling between various equipment and devices in access network 402 and core network 404. The protocols running between UE 414 and core network 404 are generally known as Non-Access Stratum (NAS) protocols.

For illustration purposes only, the terms MME 418, SGW 420, HSS 422 and PGW 426, and so on, can be server devices, but may be referred to in the subject disclosure without the word “server.” It is also understood that any form of such servers can operate in a device, system, component, or other form of centralized or distributed hardware and software. It is further noted that these terms and other terms such as bearer paths and/or interfaces are terms that can include features, methodologies, and/or fields that may be described in whole or in part by standards bodies such as the 3GPP. It is further noted that some or all embodiments of the subject disclosure may in whole or in part modify, supplement, or otherwise supersede final or proposed standards published and promulgated by 3GPP.

According to traditional implementations of LTE-EPS architectures, SGW 420 routes and forwards all user data packets. SGW 420 also acts as a mobility anchor for user plane operation during handovers between base stations, e.g., during a handover from first eNB 416a to second eNB 416b as may be the result of UE 414 moving from one area of coverage, e.g., cell, to another. SGW 420 can also terminate a downlink data path, e.g., from external network 406 to UE 414 in an idle state, and trigger a paging operation when downlink data arrives for UE 414. SGW 420 can also be configured to manage and store a context for UE 414, e.g., including one or more of parameters of the IP bearer service and network internal routing information. In addition, SGW 420 can perform administrative functions, e.g., in a visited network, such as collecting information for charging (e.g., the volume of data sent to or received from the user), and/or replicate user traffic, e.g., to support a lawful interception. SGW 420 also serves as the mobility anchor for interworking with other 3GPP technologies such as universal mobile telecommunication system (UMTS).

At any given time, UE 414 is generally in one of three different states: detached, idle, or active. The detached state is typically a transitory state in which UE 414 is powered on but is engaged in a process of searching and registering with network 402. In the active state, UE 414 is registered with access network 402 and has established a wireless connection, e.g., radio resource control (RRC) connection, with eNB 416. Whether UE 414 is in an active state can depend on the state of a packet data session, and whether there is an active packet data session. In the idle state, UE 414 is generally in a power conservation state in which UE 414 typically does not communicate packets. When UE 414 is idle, SGW 420 can terminate a downlink data path, e.g., from one peer entity 406, and triggers paging of UE 414 when data arrives for UE 414. If UE 414 responds to the page, SGW 420 can forward the IP packet to eNB 416a.

HSS 422 can manage subscription-related information for a user of UE 414. For example, HSS 422 can store information such as authorization of the user, security requirements for the user, quality of service (QoS) requirements for the user, etc. HSS 422 can also hold information about external networks 406 to which the user can connect, e.g., in the form of an APN of external networks 406. For example, MME 418 can communicate with HSS 422 to determine if UE 414 is authorized to establish a call, e.g., a voice over IP (VoIP) call before the call is established.

PCRF 424 can perform QoS management functions and policy control. PCRF 424 is responsible for policy control decision-making, as well as for controlling the flow-based charging functionalities in a policy control enforcement function (PCEF), which resides in PGW 426. PCRF 424 provides the QoS authorization, e.g., QoS class identifier and bit rates that decide how a certain data flow will be treated in the PCEF and ensures that this is in accordance with the user's subscription profile.

PGW 426 can provide connectivity between the UE 414 and one or more of the external networks 406. In illustrative network architecture 400, PGW 426 can be responsible for IP address allocation for UE 414, as well as one or more of QoS enforcement and flow-based charging, e.g., according to rules from the PCRF 424. PGW 426 is also typically responsible for filtering downlink user IP packets into the different QoS-based bearers. In at least some embodiments, such filtering can be performed based on traffic flow templates. PGW 426 can also perform QoS enforcement, e.g., for guaranteed bit rate bearers. PGW 426 also serves as a mobility anchor for interworking with non-3GPP technologies such as CDMA2000.

Within access network 402 and core network 404 there may be various bearer paths/interfaces, e.g., represented by solid lines 428 and 430. Some of the bearer paths can be referred to by a specific label. For example, solid line 428 can be considered an S1-U bearer and solid line 432 can be considered an S5/S8 bearer according to LTE-EPS architecture standards. Without limitation, reference to various interfaces, such as S1, X2, S5, S8, S11 refer to EPS interfaces. In some instances, such interface designations are combined with a suffix, e.g., a “U” or a “C” to signify whether the interface relates to a “User plane” or a “Control plane.” In addition, the core network 404 can include various signaling bearer paths/interfaces, e.g., control plane paths/interfaces represented by dashed lines 430, 434, 436, and 438. Some of the signaling bearer paths may be referred to by a specific label. For example, dashed line 430 can be considered as an S1-MME signaling bearer, dashed line 434 can be considered as an S11 signaling bearer and dashed line 436 can be considered as an S6a signaling bearer, e.g., according to LTE-EPS architecture standards. The above bearer paths and signaling bearer paths are only illustrated as examples and it should be noted that additional bearer paths and signaling bearer paths may exist that are not illustrated.

Also shown is a novel user plane path/interface, referred to as the S1-U+ interface 466. In the illustrative example, the S1-U+ user plane interface extends between the eNB 416a and PGW 426. Notably, S1-U+ path/interface does not include SGW 420, a node that is otherwise instrumental in configuring and/or managing packet forwarding between eNB 416a and one or more external networks 406 by way of PGW 426. As disclosed herein, the S1-U+ path/interface facilitates autonomous learning of peer transport layer addresses by one or more of the network nodes to facilitate a self-configuring of the packet forwarding path. In particular, such self-configuring can be accomplished during handovers in most scenarios so as to reduce any extra signaling load on the S/PGWs 420, 426 due to excessive handover events.

In some embodiments, PGW 426 is coupled to storage device 440, shown in phantom. Storage device 440 can be integral to one of the network nodes, such as PGW 426, for example, in the form of internal memory and/or disk drive. It is understood that storage device 440 can include registers suitable for storing address values. Alternatively or in addition, storage device 440 can be separate from PGW 426, for example, as an external hard drive, a flash drive, and/or network storage.

Storage device 440 selectively stores one or more values relevant to the forwarding of packet data. For example, storage device 440 can store identities and/or addresses of network entities, such as any of network nodes 418, 420, 422, 424, and 426, eNBs 416 and/or UE 414. In the illustrative example, storage device 440 includes a first storage location 442 and a second storage location 444. First storage location 442 can be dedicated to storing a Currently Used Downlink address value 442. Likewise, second storage location 444 can be dedicated to storing a Default Downlink Forwarding address value 444. PGW 426 can read and/or write values into either of storage locations 442, 444, for example, managing Currently Used Downlink Forwarding address value 442 and Default Downlink Forwarding address value 444 as disclosed herein.

In some embodiments, the Default Downlink Forwarding address for each EPS bearer is the SGW S5-U address for each EPS Bearer. The Currently Used Downlink Forwarding address” for each EPS bearer in PGW 426 can be set every time when PGW 426 receives an uplink packet, e.g., a GTP-U uplink packet, with a new source address for a corresponding EPS bearer. When UE 414 is in an idle state, the “Current Used Downlink Forwarding address” field for each EPS bearer of UE 414 can be set to a “null” or other suitable value.

In some embodiments, the Default Downlink Forwarding address is only updated when PGW 426 receives a new SGW S5-U address in a predetermined message or messages. For example, the Default Downlink Forwarding address is only updated when PGW 426 receives one of a Create Session Request, Modify Bearer Request and Create Bearer Response messages from SGW 420.

As values 442, 444 can be maintained and otherwise manipulated on a per bearer basis, it is understood that the storage locations can take the form of tables, spreadsheets, lists, and/or other data structures generally well understood and suitable for maintaining and/or otherwise manipulate forwarding addresses on a per bearer basis.

It should be noted that access network 402 and core network 404 are illustrated in a simplified block diagram in FIG. 11. In other words, either or both of access network 402 and the core network 404 can include additional network elements that are not shown, such as various routers, switches and controllers. In addition, although FIG. 11 illustrates only a single one of each of the various network elements, it should be noted that access network 402 and core network 404 can include any number of the various network elements. For example, core network 404 can include a pool (i.e., more than one) of MMEs 418, SGWs 420 or PGWs 426.

In the illustrative example, data traversing a network path between UE 414, eNB 416a, SGW 420, PGW 426 and external network 406 may be considered to constitute data transferred according to an end-to-end IP service. However, for the present disclosure, to properly perform establishment management in LTE-EPS network architecture 400, the core network, data bearer portion of the end-to-end IP service is analyzed.

An establishment may be defined herein as a connection set up request between any two elements within LTE-EPS network architecture 400. The connection set up request may be for user data or for signaling. A failed establishment may be defined as a connection set up request that was unsuccessful. A successful establishment may be defined as a connection set up request that was successful.

In one embodiment, a data bearer portion comprises a first portion (e.g., a data radio bearer 446) between UE 414 and eNB 416a, a second portion (e.g., an 51 data bearer 428) between eNB 416a and SGW 420, and a third portion (e.g., an S5/S8 bearer 432) between SGW 420 and PGW 426. Various signaling bearer portions are also illustrated in FIG. 11. For example, a first signaling portion (e.g., a signaling radio bearer 448) between UE 414 and eNB 416a, and a second signaling portion (e.g., S1 signaling bearer 430) between eNB 416a and MME 418.

In at least some embodiments, the data bearer can include tunneling, e.g., IP tunneling, by which data packets can be forwarded in an encapsulated manner, between tunnel endpoints. Tunnels, or tunnel connections can be identified in one or more nodes of network 100, e.g., by one or more of tunnel endpoint identifiers, an IP address and a user datagram protocol port number. Within a particular tunnel connection, payloads, e.g., packet data, which may or may not include protocol related information, are forwarded between tunnel endpoints.

An example of first tunnel solution 450 includes a first tunnel 452a between two tunnel endpoints 454a and 456a, and a second tunnel 452b between two tunnel endpoints 454b and 456b. In the illustrative example, first tunnel 452a is established between evolved Node B (eNodeB, eNB) 416a and SGW 420. Accordingly, first tunnel 452a includes a first tunnel endpoint 454a corresponding to an S1-U address of eNB 416a (referred to herein as the eNB S1-U address), and second tunnel endpoint 456a corresponding to an S1-U address of SGW 420 (referred to herein as the SGW S1-U address). Likewise, second tunnel 452b includes first tunnel endpoint 454b corresponding to an S5-U address of SGW 420 (referred to herein as the SGW S5-U address), and second tunnel endpoint 456b corresponding to an S5-U address of PGW 426 (referred to herein as the PGW S5-U address).

In at least some embodiments, first tunnel solution 450 is referred to as a two tunnel solution, e.g., according to the General Packet Radio Service (GPRS) Tunneling Protocol User Plane (GTPv1-U based), as described in 3GPP specification TS 29.281, incorporated herein in its entirety. It is understood that one or more tunnels are permitted between each set of tunnel end points. For example, each subscriber can have one or more tunnels, e.g., one for each Packet Data Protocol (PDP) context that they have active, as well as possibly having separate tunnels for specific connections with different quality of service requirements, and so on.

An example of second tunnel solution 458 includes a single or direct tunnel 460 between tunnel endpoints 462 and 464. In the illustrative example, direct tunnel 460 is established between eNB 416a and PGW 426, without subjecting packet transfers to processing related to SGW 420. Accordingly, direct tunnel 460 includes first tunnel endpoint 462 corresponding to the eNB S1-U address, and second tunnel endpoint 464 corresponding to the PGW S5-U address. Packet data received at either end can be encapsulated into a payload and directed to the corresponding address of the other end of the tunnel. Such direct tunneling avoids processing, e.g., by SGW 420 that would otherwise relay packets between the same two endpoints, e.g., according to a protocol, such as the GTP-U protocol.

In some scenarios, direct tunneling solution 458 can forward user plane data packets between eNB 416a and PGW 426, by way of SGW 420. That is, SGW 420 can serve a relay function, by relaying packets between two tunnel endpoints 416a, 426. In other scenarios, direct tunneling solution 458 can forward user data packets between eNB 416a and PGW 426, by way of the S1 U+ interface 466, thereby bypassing SGW 420.

Generally, UE 414 can have one or more bearers at any one time. The number and types of bearers can depend on applications, default requirements, and so on. It is understood that the techniques disclosed herein, including the configuration, management and use of various tunnel solutions 450, 458, can be applied to the bearers on an individual bases. That is, if user data packets of one bearer, say a bearer associated with a VoIP service of UE 414, then the forwarding of all packets of that bearer are handled in a similar manner. Continuing with this example, the same UE 414 can have another bearer associated with it through the same eNB 416a. This other bearer, for example, can be associated with a relatively low rate data session forwarding user data packets through core network 404 simultaneously with the first bearer. Likewise, the user data packets of the other bearer are also handled in a similar manner, without necessarily following a forwarding path or solution of the first bearer. Thus, one of the bearers may be forwarded through direct tunnel 458; whereas, another one of the bearers may be forwarded through a two-tunnel solution 450.

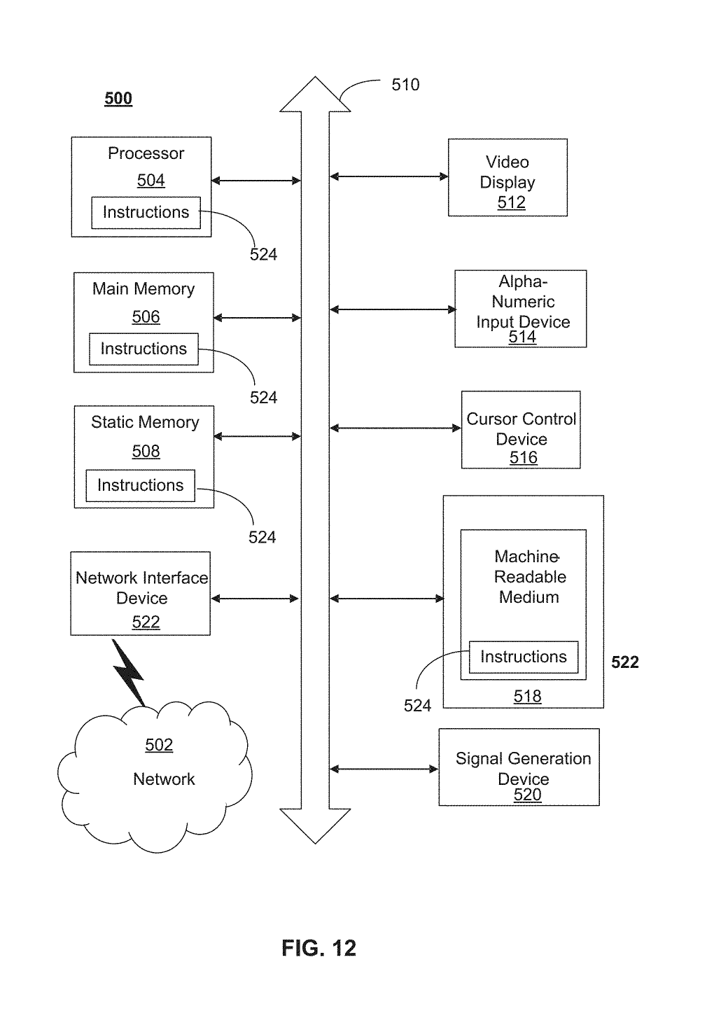

FIG. 12 depicts an exemplary diagrammatic representation of a machine in the form of a computer system 500 within which a set of instructions, when executed, may cause the machine to perform any one or more of the methods described above. One or more instances of the machine can operate, for example, as processor 504 for UE 414, eNB 416, MME 418, SGW 420, HSS 422, PCRF 424, PGW 426 and other devices. In some embodiments, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the embodiments described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium 518 having instructions 524 on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

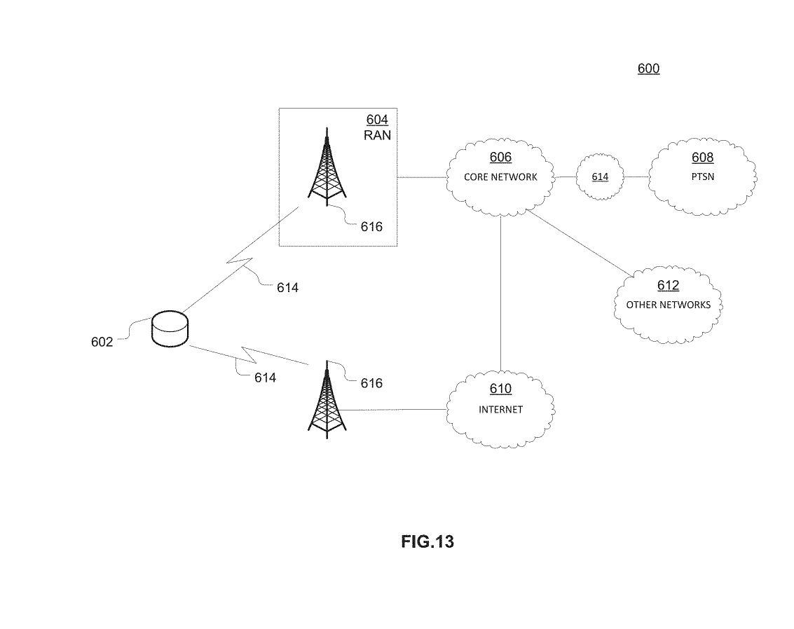

As shown in FIG. 13, telecommunication system 600 may include wireless transmit/receive units (WTRUs) 602, a Radio Access Network (RAN) 604, a core network 606, a public switched telephone network (PSTN) 608, the Internet 610, or other networks 612, though it will be appreciated that the disclosed examples contemplate any number of Wireless Transmit/Receive Units (WTRUs), base stations, networks, or network elements. Each WTRU 602 may be any type of device configured to operate or communicate in a wireless environment. For example, a WTRU may comprise a mobile device, network device or the like, or any combination thereof. By way of example, WTRUs 602 may be configured to transmit or receive wireless signals and may include a UE, a mobile station, a mobile device, a fixed or mobile subscriber unit, a pager, a cellular telephone, a PDA, a smartphone, a laptop, a netbook, a personal computer, a wireless sensor, consumer electronics, or the like. WTRUs 602 may be configured to transmit or receive wireless signals over an air interface 614.

Telecommunication system 600 may also include one or more base stations 616. Each of base stations 616 may be any type of device configured to wirelessly interface with at least one of the WTRUs 602 to facilitate access to one or more communication networks, such as core network 606, PTSN 608, Internet 610, or other networks 612. By way of example, base stations 616 may be a base transceiver station (BTS), a Node-B, an eNode B, a Home Node B, a Home eNode B, a site controller, an access point (AP), a wireless router, or the like. While base stations 616 are each depicted as a single element, it will be appreciated that base stations 616 may include any number of interconnected base stations or network elements.

RAN 604 may include one or more base stations 616, along with other network elements (not shown), such as a base station controller (BSC), a radio network controller (RNC), or relay nodes. One or more base stations 616 may be configured to transmit or receive wireless signals within a particular geographic region, which may be referred to as a cell (not shown). The cell may further be divided into cell sectors. For example, the cell associated with base station 616 may be divided into three sectors such that base station 616 may include three transceivers: one for each sector of the cell. In another example, base station 616 may employ multiple-input multiple-output (MIMO) technology and, therefore, may utilize multiple transceivers for each sector of the cell.

Base stations 616 may communicate with one or more of WTRUs 602 over air interface 614, which may be any suitable wireless communication link (e.g., radio frequency (RF), microwave, infrared (IR), ultraviolet (UV), or visible light). Air interface 614 may be established using any suitable radio access technology (RAT).

More specifically, as noted above, telecommunication system 600 may be a multiple access system and may employ one or more channel access schemes, such as Code Division Multiple Access (CDMA), Time-Division Multiple Access (TDMA), Frequency Division Multiple Access (FDMA), Orthogonal FDMA (OFDMA), Single-Carrier FDMA (SC-FDMA), or the like. For example, base station 616 in RAN 604 and WTRUs 602 connected to RAN 604 may implement a radio technology such as Universal Mobile Telecommunications System (UMTS) Terrestrial Radio Access (UTRA) that may establish air interface 614 using wideband CDMA (WCDMA). WCDMA may include communication protocols, such as High-Speed Packet Access (HSPA) or Evolved HSPA (HSPA+). HSPA may include High-Speed Downlink Packet Access (HSDPA) or High-Speed Uplink Packet Access (HSUPA).

As another example base station 616 and WTRUs 602 that are connected to RAN 604 may implement a radio technology such as Evolved UMTS Terrestrial Radio Access (E-UTRA), which may establish air interface 614 using LTE or LTE-Advanced (LTE-A).

Optionally base station 616 and WTRUs 602 connected to RAN 604 may implement radio technologies such as IEEE 802.16 (i.e., Worldwide Interoperability for Microwave Access (WiMAX)), CDMA2000, CDMA2000 1×, CDMA2000 Evolution-Data Optimized (EV-DO), Interim Standard 2000 (IS-2000), Interim Standard 95 (IS-95), Interim Standard 856 (IS-856), GSM, Enhanced Data rates for GSM Evolution (EDGE), Global System for Mobile Communication (GSM) EDGE (GERAN), or the like.

Base station 616 may be a wireless router, Home Node B, Home eNode B, or access point, for example, and may utilize any suitable RAT for facilitating wireless connectivity in a localized area, such as a place of business, a home, a vehicle, a campus, or the like. For example, base station 616 and associated WTRUs 602 may implement a radio technology such as IEEE 802.11 to establish a wireless local area network (WLAN). As another example, base station 616 and associated WTRUs 602 may implement a radio technology such as IEEE 802.15 to establish a wireless personal area network (WPAN). In yet another example, base station 616 and associated WTRUs 602 may utilize a cellular-based RAT (e.g., WCDMA, CDMA2000, GSM, LTE, LTE-A, etc.) to establish a picocell or femtocell. As shown in FIG. 13, base station 616 may have a direct connection to Internet 610. Thus, base station 616 may not be required to access Internet 610 via core network 606.

RAN 604 may be in communication with core network 606, which may be any type of network configured to provide voice, data, applications, and/or voice over internet protocol (VoIP) services to one or more WTRUs 602. For example, core network 606 may provide call control, billing services, mobile location-based services, pre-paid calling, Internet connectivity, video distribution or high-level security functions, such as user authentication. Although not shown in FIG. 13, it will be appreciated that RAN 604 or core network 606 may be in direct or indirect communication with other RANs that employ the same RAT as RAN 604 or a different RAT. For example, in addition to being connected to RAN 604, which may be utilizing an E-UTRA radio technology, core network 606 may also be in communication with another RAN (not shown) employing a GSM radio technology.

Core network 606 may also serve as a gateway for WTRUs 602 to access PSTN 608, Internet 610, or other networks 612. PSTN 608 may include circuit-switched telephone networks that provide plain old telephone service (POTS). For LTE core networks, core network 606 may use IMS core 614 to provide access to PSTN 608. Internet 610 may include a global system of interconnected computer networks or devices that use common communication protocols, such as the transmission control protocol (TCP), user datagram protocol (UDP), or Internet Protocol (IP) in the TCP/IP internet protocol suite. Other networks 612 may include wired or wireless communications networks owned or operated by other service providers. For example, other networks 612 may include another core network connected to one or more RANs, which may employ the same RAT as RAN 604 or a different RAT.

Some or all WTRUs 602 in telecommunication system 600 may include multi-mode capabilities. That is, WTRUs 602 may include multiple transceivers for communicating with different wireless networks over different wireless links. For example, one or more WTRUs 602 may be configured to communicate with base station 616, which may employ a cellular-based radio technology, and with base station 616, which may employ an IEEE 802 radio technology.

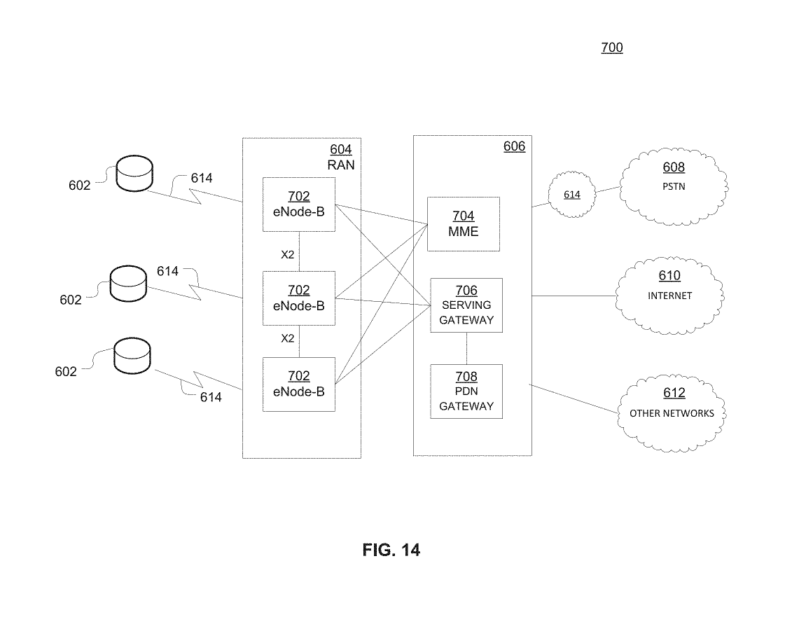

FIG. 14 is an example system 700 including RAN 604 and core network 606. As noted above, RAN 604 may employ an E-UTRA radio technology to communicate with WTRUs 602 over air interface 614. RAN 604 may also be in communication with core network 606.

RAN604 may include any number of eNode-Bs 702 while remaining consistent with the disclosed technology. One or more eNode-Bs 702 may include one or more transceivers for communicating with the WTRUs 602 over air interface 614. Optionally, eNode-Bs 702 may implement MIMO technology. Thus, one of eNode-Bs 702, for example, may use multiple antennas to transmit wireless signals to, or receive wireless signals from, one of WTRUs 602.

Each of eNode-Bs 702 may be associated with a particular cell (not shown) and may be configured to handle radio resource management decisions, handover decisions, scheduling of users in the uplink or downlink, or the like. As shown in FIG. 14 eNode-Bs 702 may communicate with one another over an X2 interface.

Core network 606 shown in FIG. 14 may include a mobility management gateway or entity (MME) 704, a serving gateway 706, or a packet data network (PDN) gateway 708. While each of the foregoing elements are depicted as part of core network 606, it will be appreciated that any one of these elements may be owned or operated by an entity other than the core network operator.

MME 704 may be connected to each of eNode-Bs 702 in RAN 604 via an S1 interface and may serve as a control node. For example, MME 704 may be responsible for authenticating users of WTRUs 602, bearer activation or deactivation, selecting a particular serving gateway during an initial attach of WTRUs 602, or the like. MME 704 may also provide a control plane function for switching between RAN 604 and other RANs (not shown) that employ other radio technologies, such as GSM or Wideband CDMA (WCDMA).

Serving gateway 706 may be connected to each of eNode-Bs 702 in RAN 604 via the S1 interface. Serving gateway 706 may generally route or forward user data packets to or from the WTRUs 602. Serving gateway 706 may also perform other functions, such as anchoring user planes during inter-eNode B handovers, triggering paging when downlink data is available for WTRUs 602, managing or storing contexts of WTRUs 602, or the like.

Serving gateway 706 may also be connected to PDN gateway 708, which may provide WTRUs 602 with access to packet-switched networks, such as Internet 610, to facilitate communications between WTRUs 602 and IP-enabled devices.

Core network 606 may facilitate communications with other networks. For example, core network 606 may provide WTRUs 602 with access to circuit-switched networks, such as PSTN 608, such as through IMS core 614, to facilitate communications between WTRUs 602 and traditional land-line communications devices. In addition, core network 606 may provide the WTRUs 602 with access to other networks 612, which may include other wired or wireless networks that are owned or operated by other service providers.

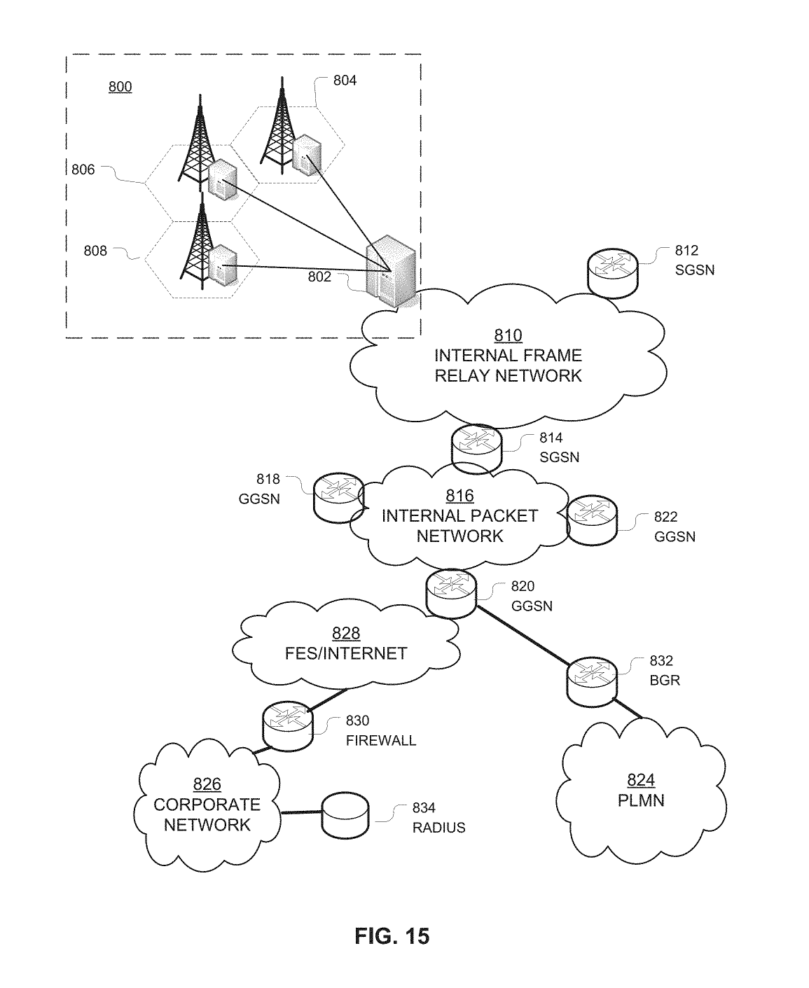

FIG. 15 depicts an overall block diagram of an example packet-based mobile cellular network environment, such as a GPRS network as described herein. In the example packet-based mobile cellular network environment shown in FIG. 15, there are a plurality of base station subsystems (BSS) 800 (only one is shown), each of which comprises a base station controller (BSC) 802 serving a plurality of Baseband Transceiver Stations (BTSs), such as BTSs 804, 806, 808. BTSs 804, 806, 808 are the access points where users of packet-based mobile devices become connected to the wireless network. In example fashion, the packet traffic originating from mobile devices is transported via an over-the-air interface to BTS 808, and from BTS 808 to BSC 802. Base station subsystems, such as BSS 800, are a part of internal frame relay network 810 that can include a Serving GPRS Support Node (SGSN), such as SGSN 812 or SGSN 814. Each SGSN 812, 814 is connected to an internal packet network 816 through which SGSN 812, 814 can route data packets to or from a plurality of gateway GPRS support nodes (GGSN) 818, 820, 822. As illustrated, SGSN 814 and GGSNs 818, 820, 822 are part of internal packet network 816. GGSNs 818, 820, 822 mainly provide an interface to external IP networks such as Public Land Mobile Network (PLMN) 824, corporate intranets/internets 826, or Fixed-End System (FES) or the public Internet 828. As illustrated, subscriber corporate network 826 may be connected to GGSN 820 via a firewall 830. PLMN 824 may be connected to GGSN 820 via a border gateway router (BGR) 832. A Remote Authentication Dial-In User Service (RADIUS) server 834 may be used for caller authentication when a user calls corporate network 826.

Generally, there may be a several cell sizes in a network, referred to as macro, micro, pico, femto or umbrella cells. The coverage area of each cell is different in different environments. Macro cells can be regarded as cells in which the base station antenna is installed in a mast or a building above average roof top level. Micro cells are cells whose antenna height is under average roof top level. Micro cells are typically used in urban areas. Pico cells are small cells having a diameter of a few dozen meters. Pico cells are used mainly indoors. Femto cells have the same size as pico cells, but a smaller transport capacity. Femto cells are used indoors, in residential or small business environments. On the other hand, umbrella cells are used to cover shadowed regions of smaller cells and fill in gaps in coverage between those cells.

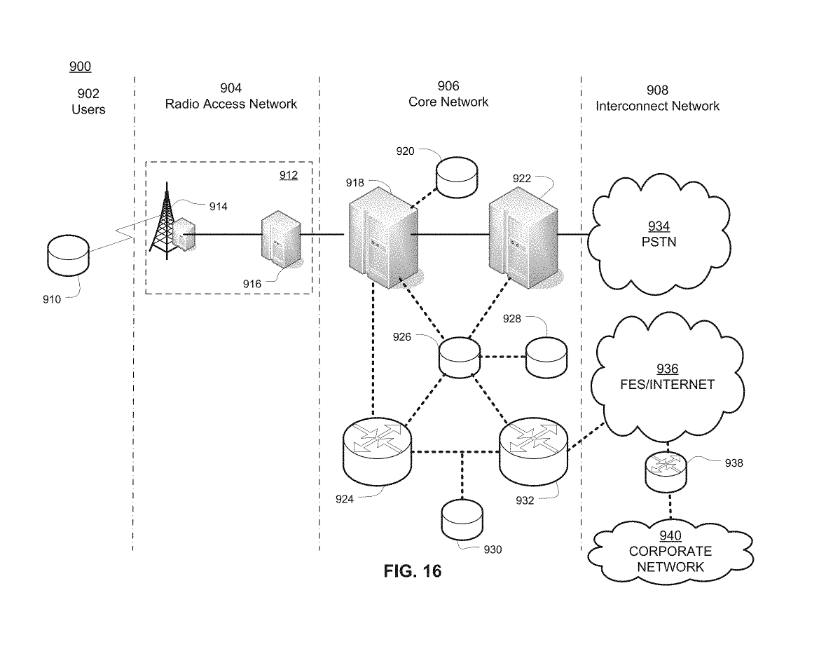

FIG. 16 illustrates an architecture of a typical GPRS network 900 as described herein. The architecture depicted in FIG. 9 may be segmented into four groups: users 902, RAN 904, core network 906, and interconnect network 908. Users 902 comprise a plurality of end users, who each may use one or more devices 910. Note that device 910 is referred to as a mobile subscriber (MS) in the description of network shown in FIG. 9. In an example, device 910 comprises a communications device (e.g., mobile device 102, mobile positioning center 116, network device 300, any of detected devices 500, second device 508, access device 604, access device 606, access device 608, access device 610 or the like, or any combination thereof). Radio access network 904 comprises a plurality of BSSs such as BSS 912, which includes a BTS 914 and a BSC 916. Core network 906 may include a host of various network elements. As illustrated in FIG. 9, core network 906 may comprise MSC 918, service control point (SCP) 920, gateway MSC (GMSC) 922, SGSN 924, home location register (HLR) 926, authentication center (AuC) 928, domain name system (DNS) server 930, and GGSN 932. Interconnect network 908 may also comprise a host of various networks or other network elements. As illustrated in FIG. 9, interconnect network 908 comprises a PSTN 934, an FES/Internet 936, firewall 938, or a corporate network 940.

An MSC can be connected to a large number of BSCs. At MSC 918, for instance, depending on the type of traffic, the traffic may be separated in that voice may be sent to PSTN 934 through GMSC 922, or data may be sent to SGSN 924, which then sends the data traffic to GGSN 932 for further forwarding.

When MSC 918 receives call traffic, for example, from BSC 916, it sends a query to a database hosted by SCP 920, which processes the request and issues a response to MSC 918 so that it may continue call processing as appropriate.

Home Location Register (HLR) 926 is a centralized database for users to register to the GPRS network. HLR 926 stores static information about the subscribers such as the International Mobile Subscriber Identity (IMSI), subscribed services, or a key for authenticating the subscriber. HLR 926 also stores dynamic subscriber information such as the current location of the MS. Associated with HLR 926 is AuC 928, which is a database that contains the algorithms for authenticating subscribers and includes the associated keys for encryption to safeguard the user input for authentication.

In the following, depending on context, “mobile subscriber” or “MS” sometimes refers to the end user and sometimes to the actual portable device, such as a mobile device, used by an end user of the mobile cellular service. When a mobile subscriber turns on his or her mobile device, the mobile device goes through an attach process by which the mobile device attaches to an SGSN of the GPRS network. In FIG. 16, when MS 910 initiates the attach process by turning on the network capabilities of the mobile device, an attach request is sent by MS 910 to SGSN 924. The SGSN 924 queries another SGSN, to which MS 910 was attached before, for the identity of MS 910. Upon receiving the identity of MS 910 from the other SGSN, SGSN 924 requests more information from MS 910. This information is used to authenticate MS 910 together with the information provided by HLR 926. Once verified, SGSN 924 sends a location update to HLR 926 indicating the change of location to a new SGSN, in this case SGSN 924. HLR 926 notifies the old SGSN, to which MS 910 was attached before, to cancel the location process for MS 910. HLR 926 then notifies SGSN 924 that the location update has been performed. At this time, SGSN 924 sends an Attach Accept message to MS 910, which in turn sends an Attach Complete message to SGSN 924.

Next, MS 910 establishes a user session with the destination network, corporate network 940, by going through a Packet Data Protocol (PDP) activation process. Briefly, in the process, MS 910 requests access to the Access Point Name (APN), for example, UPS.com, and SGSN 924 receives the activation request from MS 910. SGSN 924 then initiates a DNS query to learn which GGSN 932 has access to the UPS.com APN. The DNS query is sent to a DNS server within core network 906, such as DNS server 930, which is provisioned to map to one or more GGSNs in core network 906. Based on the APN, the mapped GGSN 932 can access requested corporate network 940. SGSN 924 then sends to GGSN 932 a Create PDP Context Request message that contains necessary information. GGSN 932 sends a Create PDP Context Response message to SGSN 924, which then sends an Activate PDP Context Accept message to MS 910.

Once activated, data packets of the call made by MS 910 can then go through RAN 904, core network 906, and interconnect network 908, in a particular FES/Internet 936 and firewall 938, to reach corporate network 940.

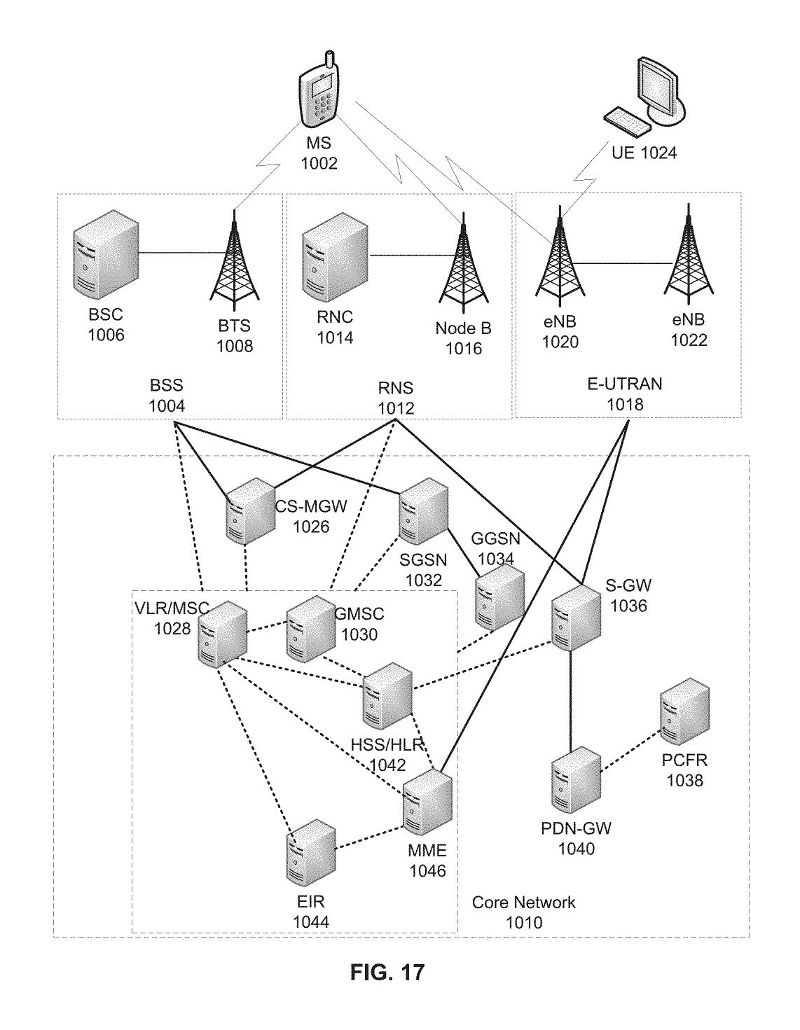

FIG. 17 illustrates a PLMN block diagram view of an example architecture that may be replaced by a telecommunications system. In FIG. 17, solid lines may represent user traffic signals, and dashed lines may represent support signaling. MS 1002 is the physical equipment used by the PLMN subscriber. For example, network device 300, the like, or any combination thereof may serve as MS 1002. MS 1002 may be one of, but not limited to, a cellular telephone, a cellular telephone in combination with another electronic device or any other wireless mobile communication device.

MS 1002 may communicate wirelessly with BSS 1004. BSS 1004 contains BSC 1006 and a BTS 1008. BSS 1004 may include a single BSC 1006/BTS 1008 pair (base station) or a system of BSC/BTS pairs that are part of a larger network. BSS 1004 is responsible for communicating with MS 1002 and may support one or more cells. BSS 1004 is responsible for handling cellular traffic and signaling between MS 1002 and a core network 1010. Typically, BSS 1004 performs functions that include, but are not limited to, digital conversion of speech channels, allocation of channels to mobile devices, paging, or transmission/reception of cellular signals.

Additionally, MS 1002 may communicate wirelessly with RNS 1012. RNS 1012 contains a Radio Network Controller (RNC) 1014 and one or more Nodes B 1016. RNS 1012 may support one or more cells. RNS 1012 may also include one or more RNC 1014/Node B 1016 pairs or alternatively a single RNC 1014 may manage multiple Nodes B 1016. RNS 1012 is responsible for communicating with MS 1002 in its geographically defined area. RNC 1014 is responsible for controlling Nodes B 1016 that are connected to it and is a control element in a UMTS radio access network. RNC 1014 performs functions such as, but not limited to, load control, packet scheduling, handover control, security functions, or controlling MS 1002 access to core network 1010.

An E-UTRA Network (E-UTRAN) 1018 is a RAN that provides wireless data communications for MS 1002 and UE 1024. E-UTRAN 1018 provides higher data rates than traditional UMTS. It is part of the LTE upgrade for mobile networks, and later releases meet the requirements of the International Mobile Telecommunications (IMT) Advanced and are commonly known as a 4G networks. E-UTRAN 1018 may include of series of logical network components such as E-UTRAN Node B (eNB) 1020 and E-UTRAN Node B (eNB) 1022. E-UTRAN 1018 may contain one or more eNBs. User equipment (UE) 1024 may be any mobile device capable of connecting to E-UTRAN 1018 including, but not limited to, a personal computer, laptop, mobile device, wireless router, or other device capable of wireless connectivity to E-UTRAN 1018. The improved performance of the E-UTRAN 1018 relative to a typical UMTS network allows for increased bandwidth, spectral efficiency, and functionality including, but not limited to, voice, high-speed applications, large data transfer or IPTV, while still allowing for full mobility.

Typically MS 1002 may communicate with any or all of BSS 1004, RNS 1012, or E-UTRAN 1018. In an illustrative system, each of BSS 1004, RNS 1012, and E-UTRAN 1018 may provide MS 1002 with access to core network 1010. Core network 1010 may include of a series of devices that route data and communications between end users. Core network 1010 may provide network service functions to users in the circuit switched (CS) domain or the packet switched (PS) domain. The CS domain refers to connections in which dedicated network resources are allocated at the time of connection establishment and then released when the connection is terminated. The PS domain refers to communications and data transfers that make use of autonomous groupings of bits called packets. Each packet may be routed, manipulated, processed or handled independently of all other packets in the PS domain and does not require dedicated network resources.

The circuit-switched Media Gateway (MGW) function (CS-MGW) 1026 is part of core network 1010, and interacts with VLR/MSC server 1028 and GMSC server 1030 in order to facilitate core network 1010 resource control in the CS domain. Functions of CS-MGW 1026 include, but are not limited to, media conversion, bearer control, payload processing or other mobile network processing such as handover or anchoring. CS-MGW 1026 may receive connections to MS 1002 through BSS 1004 or RNS 1012.

SGSN 1032 stores subscriber data regarding MS 1002 in order to facilitate network functionality. SGSN 1032 may store subscription information such as, but not limited to, the IMSI, temporary identities, or PDP addresses. SGSN 1032 may also store location information such as, but not limited to, GGSN address for each GGSN 1034 where an active PDP exists. GGSN 1034 may implement a location register function to store subscriber data it receives from SGSN 1032 such as subscription or location information.

Serving gateway (S-GW) 1036 is an interface which provides connectivity between E-UTRAN 1018 and core network 1010. Functions of S-GW 1036 include, but are not limited to, packet routing, packet forwarding, transport level packet processing, or user plane mobility anchoring for inter-network mobility. PCRF 1038 uses information gathered from P-GW 1036, as well as other sources, to make applicable policy and charging decisions related to data flows, network resources or other network administration functions. PDN gateway (PDN-GW) 1040 may provide user-to-services connectivity functionality including, but not limited to, GPRS/EPC network anchoring, bearer session anchoring and control, or IP address allocation for PS domain connections.

HSS/HLR 1042 is a database for user information and stores subscription data regarding MS 1002 or UE 1024 for handling calls or data sessions. Networks may contain one HSS/HLR 1042 or more if additional resources are required. Example data stored by HSS 1042 include, but is not limited to, user identification, numbering or addressing information, security information, or location information. HSS/HLR 1042 may also provide call or session establishment procedures in both the PS and CS domains.

VLR/MSC Server 1028 provides user location functionality. When MS 1002 enters a new network location, it begins a registration procedure. A MSC server for that location transfers the location information to the VLR for the area. A VLR and MSC server may be located in the same computing environment, as is shown by VLR/MSC server 1028, or alternatively may be located in separate computing environments. A VLR may contain, but is not limited to, user information such as the IMSI, the Temporary Mobile Station Identity (TMSI), the Local Mobile Station Identity (LMSI), the last known location of the mobile station, or the SGSN where the mobile station was previously registered. The MSC server may contain information such as, but not limited to, procedures for MS 1002 registration or procedures for handover of MS 1002 to a different section of core network 1010. Gateway Mobile Services Switching Center (GMSC) server 1030 may serve as a connection to alternate GMSC servers for other MSs in larger networks.

Equipment Identity Register (EIR) 1044 is a logical element which may store the IMEI for MS 1002. User equipment may be classified as either “white listed” or “black listed” depending on its status in the network. If MS 1002 is stolen and put to use by an unauthorized user, it may be registered as “black listed” in EIR 1044, preventing its use on the network. A MME 1046 is a control node which may track MS 1002 or UE 1024 if the devices are idle. Additional functionality may include the ability of MME 1046 to contact idle MS 1002 or UE 1024 if retransmission of a previous session is required.

As described herein, a telecommunications system wherein management and control utilizing a software designed network (SDN) and an internet protocol are based, at least in part, on user equipment, may provide a wireless management and control framework that enables common wireless management and control, such as mobility management, radio resource management, QoS, load balancing, etc., across many wireless technologies, e.g. LTE, Wi-Fi, and future 5G access technologies; decoupling the mobility control from data planes to let them evolve and scale independently; reducing network state maintained in the network based on user equipment types to reduce network cost and allow massive scale; shortening cycle time and improving network upgradability; flexibility in creating end-to-end services based on types of user equipment and applications, thus improve customer experience; or improving user equipment power efficiency and battery life—especially for simple Machine-to-Machine (M2M) and Internet of Things (IoT) sensors/devices—through enhanced wireless management.

While examples of a system and method in which network policies may be automatically generated in real-time or near real time have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, Compact Disc-Read-Only Memory devices (CD-ROMs), Digital Versatile Discs, or, Digital Video Discs (DVDs), hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language, and may be combined with hardware implementations.

The methods and devices associated with the disclosure described herein also may be practiced via communications embodied in the form of program code that is transmitted over some transmission medium, such as over electrical wiring or cabling, through fiber optics, or via any other form of transmission, over the air (OTA), or firmware over the air (FOTA), wherein, when the program code is received and loaded into and executed by a machine, such as an Erasable Programmable Read-Only Memory (EPROM), a gate array, a programmable logic device (PLD), a client computer, or the like, the machine becomes an device for implementing telecommunications as described herein. When implemented on a general-purpose processor, the program code combines with the processor to provide a unique device that operates to invoke the functionality of the system described herein. Functions described as operating on a client device may be operating on a server and vice versa.

It will be apparent to those skilled in the art that various modifications and variations may be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system for generating network policies comprising:
A run-time execution platform configured to manage operations of a network;
An analytics engine in communication with the run-time execution platform;
An input-output interface associated with the analytics engine; and
a processor coupled to the input-output interface and wherein the processor is coupled to a memory, the memory having stored thereon executable instructions that when executed by the processor cause the processor to effectuate operations comprising:
creating a set of baseline performance statistics associated with the network;
identifying at least one anomaly in the network;
based on the identifying step, scoring the anomalies; and
setting policies for operation of the network.

2. The system of claim 1 wherein the identifying step comprises receiving an input from monitoring of the network.

3. The system of claim 2 wherein the input comprises one of an alarm, a sensor output, an action log, a maintenance log and a loading measurement.

4. The system of claim 1 wherein the identifying step comprises an input from an operator or a set of vendor rules.

5. The system of claim 1 wherein the creating step comprises creating statistical templates.

6. The system of claim 1 wherein the creating step comprises generating spatio-temporal patterns of normal network operations.

7. The system of claim 6 wherein the spatio-temporal patterns are updated periodically. s.

8. The system of claim 6 wherein the spatio-temporal patterns also include network failure modeling.

9. The system of claim 1 wherein the operations further comprise generating at least one signature for each anomaly identified.

10. The system of claim 1 wherein the network is implemented using virtual network functions.

11. The system of claim 1 wherein the operations further include revising the policies based on receiving additional inputs.

12. The system of claim 1 wherein the operations further comprise determining a source of the anomaly.

13. The system of claim 12 wherein the operations further comprise providing a solution to correct the anomaly.

14. The system of claim 1 wherein the setting of the policies are based on predictive analytics.

15. A method comprising:
Creating a statistical template for operation of a network;
Scoring a plurality of anomalies detected in the network;
Modeling symptoms of the plurality of the anomalies;
Determining at least one signature for each group of symptoms;
Grouping the anomalies based on the determining step:
Developing corrective actions for each subgroup of anomalies.

16. The method of claim 15 further comprising developing rules for operation of the network.

17. The method of claim 16 wherein the method is repeated based on further on inputs from the network.

18. The method of claim 15 wherein the developing step is performed using predictive analytics.

19. The method of claim 15 further comprising receiving an input from the network, the input comprising one of an alarm, system log, maintenance log, a counter, and tickets.

20. An analytics engine comprising:
an input-output interface associated with the analytics engine; and
a processor coupled to the input-output interface and wherein the processor is coupled to a memory, the memory having stored thereon executable instructions that when executed by the processor cause the processor to effectuate operations comprising:
receiving inputs from a network;
creating a set of baseline performance statistics associated with the network;
identifying anomalies in the network;
based on the identifying step, scoring the anomalies; and
setting policies for operation of the network based on the scoring step and wherein the polices are set based on predictive analytics.
